(19) United States
(12) Patent Application Publication
(10) Pub. No.: US 2020/0189092 A1
(43) Pub. Date: Jun. 18, 2020

(54) ASSIST DEVICE

(71) Applicant: JTEKT Corporation, Osaka-shi (JP)

(72) Inventors: Yoshitaka YOSHIMI, Kashiba-shi (JP); Toshiki KUMENO, Kyoto-shi (JP)

(73) Assignee: JTEKT Corporation, Osaka-shi (JP)

(21) Appl. No.: 15/929,182

(22) Filed: Dec. 10, 2019

(30) Foreign Application Priority Data
Dec. 14, 2018 (JP) 2018-234687

(51) Int. Cl. B25J 9/00; B25J 9/16; G05B 13/02

(52) U.S. Cl. CPC B25J 9/0006; B25J 9/1633; G05B 2219/40305; G05B 13/0265; B25J 9/1694

(57) ABSTRACT

An assist device includes body gear, an actuator unit, an angle detector, a torque detector, a load detector, and a controller. The angle detector is configured to detect a forward leaning angle of the hips of a person relative to his or her thighs. The torque detector is configured to detect a torque-related amount related with a torque based on the forward leaning angle. The load detector is configured to detect a load-related amount based on either a baggage mass or a baggage weight. The controller is configured to calculate the assisting torque based on the torque-related amount and the load-related amount. The controller is configured to control the actuator unit based on the assisting torque.

### INCORPORATION BY REFERENCE

The disclosure of Japanese Patent Application No. 2018-234687 filed on Dec. 14, 2018 including the specification, drawings and abstract is incorporated herein by reference in its entirety.

### BACKGROUND

### 1. Technical Field

The present disclosure relates to an assist device that assists a person being assisted in moving his or her body parts to be assisted.

### 2. Description of Related Art

In recent years, various types of assist devices that assist baggage lifting or lowering motion have been disclosed. These assist devices are configured to appropriately assist the motion of a person being assisted (a person wearing the assist device) based on the assumption that the person being assisted is holding baggage. For example, during a baggage lifting motion, the assist devices assist the motion of the person being assisted as the person stoops and picks up baggage and from this state stands up while holding the baggage.

In some cases, however, the assist devices assist the motion of the person being assisted also when the person who is sitting in a chair, for example, to take a rest, stands up without holding baggage. Assisting the motion of the person being assisted when the person is not holding baggage can give the person an unpleasant sensation, and is therefore not very favorable. It is desired that an assist device does not assist a lifting motion (and a motion similar to a lifting motion) and a lowering motion (and a motion similar to a lowering motion) more than necessary when the person being assisted is not holding baggage.

In the case where the person being assisted holds and lifts baggage, for example, if the baggage is relatively light, assisting this motion with an excessively large assisting torque is likely to give the person an unpleasant sensation. Conversely, if the baggage is relatively heavy, assisting the motion with an excessively small assisting torque is likely to dissatisfy the person. It is therefore desired that when the person being assisted is holding baggage, the amount of assisting torque is automatically adjusted according to the mass (or weight) of the baggage.

For example, Japanese Patent Application Publication No. 2016-150420 (JP 2016-150420 A) discloses a power assist robot device that can assist a motion of lifting a heavy object and a walking motion with a small number of driving sources, without hindering the motion of a wearer. This power assist robot device assists the wearer in moving his or her thighs relative to the hips. Moreover, this power assist robot device includes, on the soles of the right and left feet of the wearer, a toe switch and a heel switch that detect whether or not a load equal to or larger than a predetermined amount is applied to the soles of his or her feet, and according to the state of these switches, determines to which of a walking motion, an upper-body motion (lifting motion), a crouching motion, etc. the motion state of the wearer corresponds.

### SUMMARY

In JP 2016-150420 A, a motion, such as a walking motion, is determined by means of switches (toe switches, heel switches, and glove switches) for opening and closing an electric circuit that detects whether or not the wearer is holding baggage, and a torque proportional to the hip joint angle is output. When the wearer performs a lifting motion (or a motion similar to a lifting motion) without holding baggage (e.g., a motion of standing up from a state of sitting in a chair), this power assist robot device may give the wearer an unpleasant sensation by exerting an unnecessarily large assisting torque. Moreover, since the amount of assisting torque is not automatically adjusted according to the mass (weight) of the baggage, in the case where the wearer holds and lifts baggage, for example, if the baggage is light, the assisting torque may be excessively large and the wearer may feel an unpleasant sensation, whereas if the baggage is heavy, the assisting torque may be excessively small and the wearer may feel dissatisfaction.

When assisting baggage lifting or lowering motion, the present disclosure automatically adjusts the amount of assisting torque according to the mass or weight of the baggage that the person being assisted is holding, thereby reducing an unpleasant feeling or dissatisfaction that the person being assisted may feel.

An aspect of the present disclosure is an assist device. This assist device includes body gear, an actuator unit, an angle detector, a torque detector, a load detector, and a controller. The body gear is worn at least around hips of a person. The actuator unit is attached to the body gear and worn on thighs of the person. The actuator unit is configured to generate an assisting torque for assisting a predetermined motion of the person. The predetermined motion is at least either a motion of the thighs of the person relative to his or her hips or a motion of the hips of the person relative to his or her thighs. The angle detector is configured to detect a forward leaning angle of the hips of the person relative to his or her thighs. The torque detector is configured to detect a torque-related amount that is related with a torque based on the forward leaning angle detected by the angle detector. The load detector is configured to detect a load-related amount based on either a baggage mass or a baggage weight. The baggage mass is mass of baggage that the person is holding, and the baggage weight is weight of the baggage. The controller is configured to calculate the assisting torque based on the torque-related amount and the load-related amount. The controller is configured to control the actuator unit based on the calculated assisting torque.

In this configuration, the assisting torque is calculated based on the torque-related amount (e.g., a combined torque combining an assisting torque and a person being assisted-exerted torque that is exerted by the person being assisted) detected by the torque detector, and on the load-related amount (the mass or weight of the baggage that the person being assisted is holding) detected by the load detector. Thus, when assisting a baggage lifting or lowering motion, this assist device can automatically adjust the amount of assisting torque according to the mass or weight of the baggage that the person being assisted is holding, thereby reducing an unpleasant feeling or dissatisfaction that the person being assisted may feel.

In the above assist device, the load detector may be disposed on soles of feet of the person. The controller may be configured to detect a person-being-assisted mass that is the mass of the person, based on a detection signal sent from the load detector when the person is not holding the baggage. The controller may be configured to detect a combined mass that is a total mass of the person and the baggage, based on a detection signal sent from the load detector when the person is holding the baggage. The controller may be configured to detect the baggage mass based on the combined mass and the person-being-assisted mass.

In the above assist device, the load detector may be disposed on the soles of feet of the person. The controller may be configured to detect a person-being-assisted weight that is the weight of the person, based on a detection signal sent from the load detector when the person is not holding the baggage. The controller may be configured to detect a combined weight that is a total weight of the person and the baggage, based on a detection signal sent from the load detector when the person is holding the baggage. The controller may be configured to detect the baggage weight based on the combined weight and the person-being-assisted weight.

Thus, the person-being-assisted mass or the person-being-assisted weight can be detected appropriately and easily, and the combined mass (person-being-assisted mass+baggage mass) or the combined weight (person-being-assisted weight+baggage weight) can be detected appropriately and easily. Therefore, the baggage mass or the baggage weight can be detected appropriately and easily.

The above assist device may further include an acceleration rate detector configured to detect a body motion acceleration rate that is an acceleration rate of a motion of a part of the body of the person. The controller may be configured to calculate the load-related amount based on one of the baggage mass and the baggage weight detected by the load detector and on the body motion acceleration rate detected by the acceleration rate detector.

For example, in the case of a lifting motion, when the person being assisted stoops with momentum and picks up baggage and then stands up with momentum, a body acceleration rate-attributable load that is a load according to the acceleration rate of the motion of the body of the person being assisted may be added as an error to the total load of the mass (weight) of the person being assisted and the mass (weight) of the baggage. Even in this case, the above configuration can appropriately eliminate the body acceleration rate-attributable load from the load-related amount, so that the load-related amount can be obtained with higher accuracy.

The above assist device may further include a storage device that stores a plurality of maps in which an assisting torque-related amount related with the assisting torque is preset according to the load-related amount. The controller may be configured to calculate the assisting torque by using one of the maps selected based on the load-related amount when obtaining the assisting torque.

In this configuration, an assisting torque according to the mass or weight of baggage that the person being assisted is holding can be obtained more easily.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view illustrating an example of the overall configuration of an assist device;

FIG. 2 is an exploded perspective view of the assist device shown in FIG. 1;

FIG. 3 is a perspective view illustrating an example of the external appearance of body gear in the assist device shown in FIG. 1;

FIG. 4 is a perspective view illustrating load detection means and an example of the external appearance of an actuator unit in the assist device shown in FIG. 1;

FIG. 5 is a perspective view illustrating an example of the external appearance of a frame that is a component of the body gear;

FIG. 6 is a development illustrating an example of the structure of a hip support that is a component of the body gear;

FIG. 7 is a development illustrating an example of the structure of a jacket that is a component of the body gear;

FIG. 8 is a perspective view of a (right) actuator unit of the assist device shown in FIG. 1;

FIG. 9 is a perspective view illustrating another example of the (right) actuator unit shown in FIG. 8;

FIG. 10 is an exploded perspective view illustrating an example of the internal structure of the actuator unit;

FIG. 11 is a sectional view illustrating an example of the internal structure of the actuator unit;

FIG. 12 is a view illustrating an upright standing state in which a person being assisted wearing the assist device stands with a straight back;

FIG. 13 is a view illustrating a state where the person being assisted has assumed a forward leaning posture from the state shown in FIG. 12 and the frame etc. have turned around an imaginary turning axis;

FIG. 14 is a view illustrating an example of the external appearance of a manipulation unit;

FIG. 15 is a view illustrating inputs into and outputs from a controller;

FIG. 16 is tables illustrating changes (adjustments) made from the manipulation unit to a motion mode, a gain, and an amount increasing speed;

FIG. 17 is a control block diagram showing how the controller controls the actuator unit;

FIG. 18 is a flowchart illustrating an entire processing procedure based on the control block diagram shown in FIG. 17;

FIG. 19 is a flowchart illustrating details of a process [S100: adjustment determination, input processing, and torque change amount etc. calculation] in the flowchart shown in FIG. 18;

FIG. 20 is a flowchart illustrating details of a process [S200: motion type determination] in the flowchart shown in FIG. 18;

FIG. 21 is a flowchart illustrating details of a process [S300: load determination (determination of a gain Cₚ)] in the flowchart shown in FIG. 18;

FIG. 22 is a view illustrating a load that is detected by the load detection means in an stationary upright standing state in which the person being assisted is not holding baggage;

FIG. 23 is a view illustrating a load that is detected by the load detection means in a state where the person being assisted has stooped from the state shown in FIG. 22 and held and lifted the baggage;

FIG. 24 is a view illustrating an example of a baggage mass that was actually obtained based on a detection signal from the load detection means when the person being assisted stooped and picked up baggage and then lifted the baggage;

FIG. 25 is a view in which acceleration rate detection means is added compared with the state shown in FIG. 22, and which illustrates acceleration rates detected by the acceleration rate detection means and a load detected by the load detection means;

FIG. 26 is a view illustrating acceleration rates detected by the acceleration rate detection means and a load detected by the load detection means in a state where the person being assisted has stooped from the state shown in FIG. 25 and held and lifted the baggage;

FIG. 27 is a view illustrating an example of a baggage mass that was actually obtained based on a detection signal from the load detection means and a detection signal from the acceleration rate detection means when the person being assisted stooped and picked up baggage and then lifted the baggage;

FIG. 28 is a flowchart illustrating details of a process [SD000R: (right) lowering] in the flowchart shown in FIG. 18;

FIG. 29 is a view illustrating how the person being assisted performs a lowering task;

FIG. 30 is a graph illustrating an example of a person being assisted-exerted torque change amount-vs-amount of assistance characteristic;

FIG. 31 is a graph illustrating an example of a forward leaning angle-vs-lowering torque limit value characteristic;

FIG. 32 is a graph illustrating how the forward leaning angle and the lowering assisting torque change over time while the person being assisted performs a lowering task;

FIG. 33 is a flowchart illustrating details of a process [SU000: lifting] in the flowchart shown in FIG. 18;

FIG. 34 is a state shift chart illustrating details of a process [SS000: motion state determination] in the flowchart shown in FIG. 33;

FIG. 35 is a graph illustrating how the forward leaning angle and the lifting assisting torque change as the motion state shifts while the person being assisted performs a lifting task;

FIG. 36 is a flowchart illustrating details of a process [SS100R: (right) amount increasing speed switching determination] in the flowchart shown in FIG. 33;

FIG. 37 is a graph illustrating examples of a time-vs-switching lower limit characteristic and a time-vs-switching upper limit characteristic;

FIG. 38 is a table illustrating an example of an amount increasing speed-vs-shift time characteristic;

FIG. 39 is a graph illustrating an example of a time-vs-amount of assistance characteristic;

FIG. 40 is a flowchart illustrating details of a process [SS170R: (right) assisting torque calculation] in the flowchart shown in FIG. 33;

FIG. 41 is graphs illustrating examples of a time-vs-lifting torque characteristic and a forward leaning angle-vs-maximum lifting torque characteristic;

FIG. 42 is a table illustrating an example of a gain-vs-damping coefficient characteristic; and

FIG. 43 is a graph illustrating an example of an assistance ratio-vs-torque damping ratio characteristic.

### DETAILED DESCRIPTION OF EMBODIMENTS

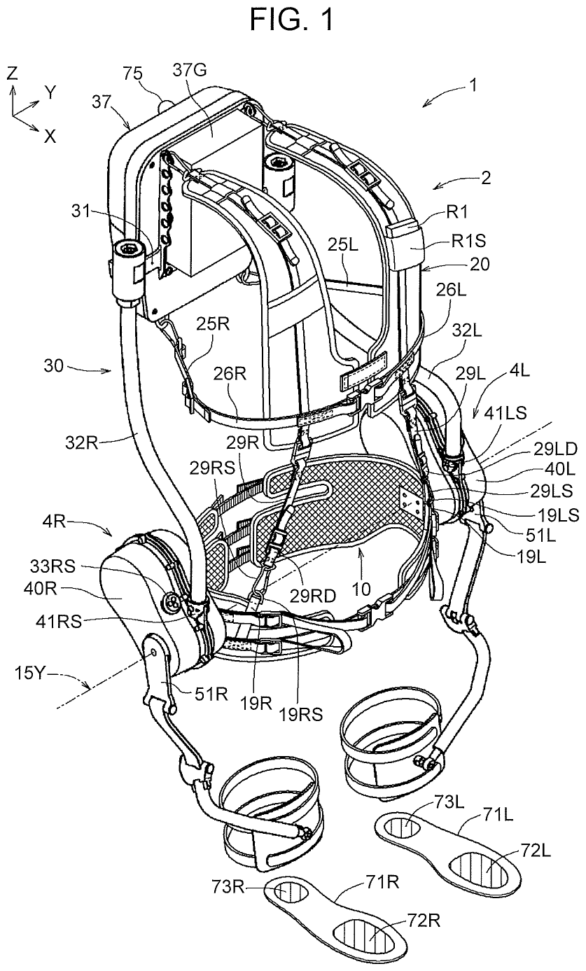

The overall structure of an assist device 1 will be described below based on FIG. 1 to FIG. 16. The assist device 1 is a device that assists a person being assisted, for example, in turning his or her thighs relative to the hips (or his or her hips relative to the thighs) when lifting baggage (or lowering baggage) and in turning his or her thighs relative to the hips when walking. The X-axis, Y-axis, and Z-axis in the drawings are orthogonal to one another, and as seen from the person being assisted wearing the assist device, an X-axis direction, Y-axis direction, and Z-axis direction correspond to a forward direction, leftward direction, and upward direction, respectively.

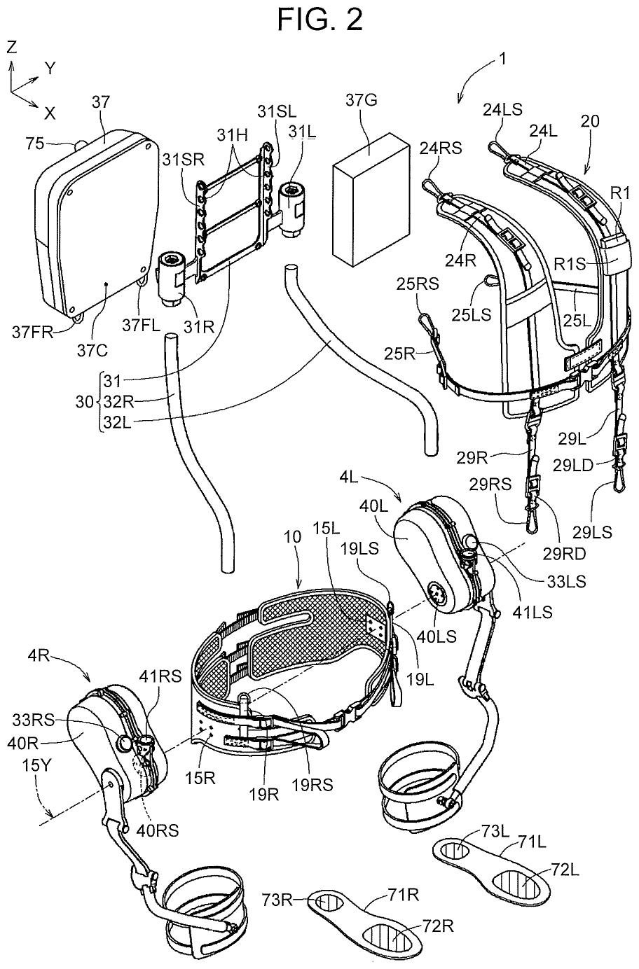

FIG. 1 shows an external appearance of the entire assist device 1. FIG. 2 is an exploded perspective view of the assist device 1 shown in FIG. 1.

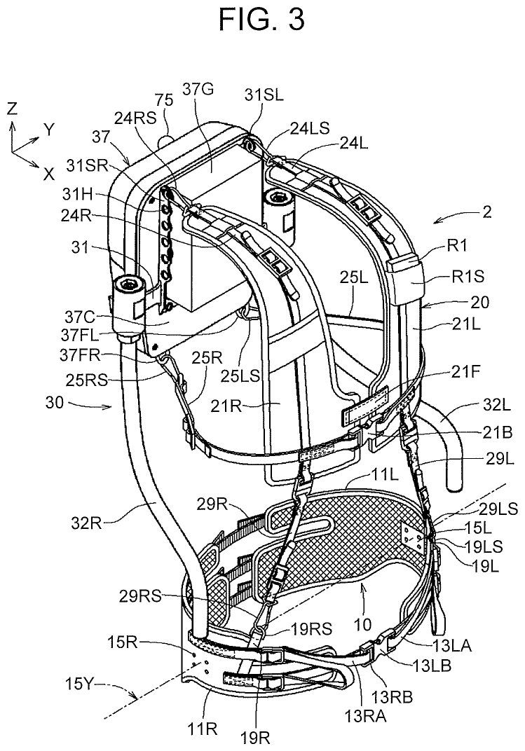

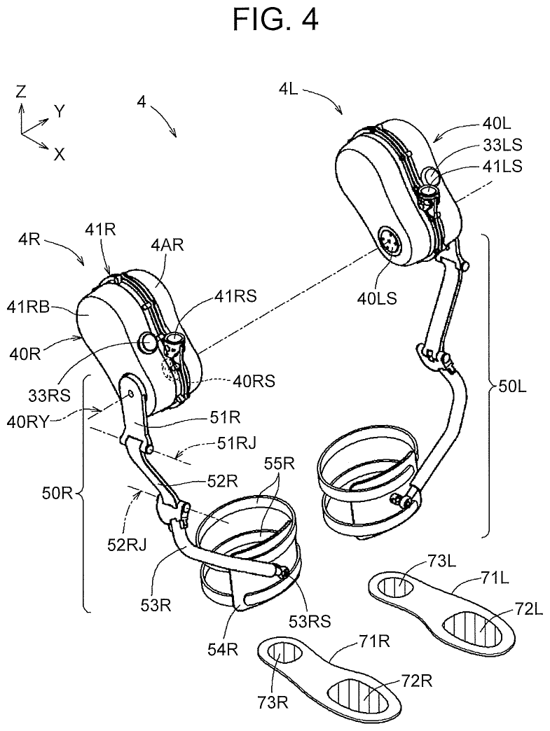

As shown in the exploded perspective view of FIG. 2, the assist device 1 is composed of a hip support 10, a jacket 20, a frame 30, a backpack 37, a cushion 37G, a right actuator unit 4R, a left actuator unit 4L, load detection units 71R, 71L etc. The hip support 10, the jacket 20, the frame 30, the backpack 37, and the cushion 37G compose body gear 2 (see FIG. 3), and the right actuator unit 4R and the left actuator unit 4L compose an actuator unit 4 (see FIG. 4). The backpack 37 is provided with acceleration rate detection means 75. The assist device 1 further has a manipulation unit R1 (so-called remote controller) that is used by the person being assisted to adjust a motion mode (lowering assistance, lifting assistance, etc.), a gain in an assisting torque, and a speed with which the amount of assisting torque is increased, or to check the adjusted state etc., and a housing part R1S that houses the manipulation unit R1.

The load detection units 71R, 71L are, for example, shoe insoles. The load detection unit 71R is disposed inside a right shoe of the person being assisted, on the sole of the right foot of the person being assisted, and the load detection unit 71L is disposed inside a left shoe of the person being assisted, on the sole of the left foot of the person being assisted. The load detection unit 71R is provided with load detection means 72R (e.g., a pressure sensor) capable of detecting a load on the sole of the right foot of the person being assisted, around the vicinity of the toe, and load detection means 73R (e.g., a pressure sensor) capable of detecting a load on the sole of the right foot of the person being assisted, around the vicinity of the heel. Although this is not shown, the load detection unit 71R has also wireless communication means for wirelessly transmitting detection signals from the load detection means 72R, 73R to the manipulation unit R1, a power source for this communication means, etc. Similarly, the load detection unit 71L has load detection means 72L, 73L, wireless communication means, a power source, etc. Since these components are the same as those of the load detection unit 71R, the description thereof will be omitted.

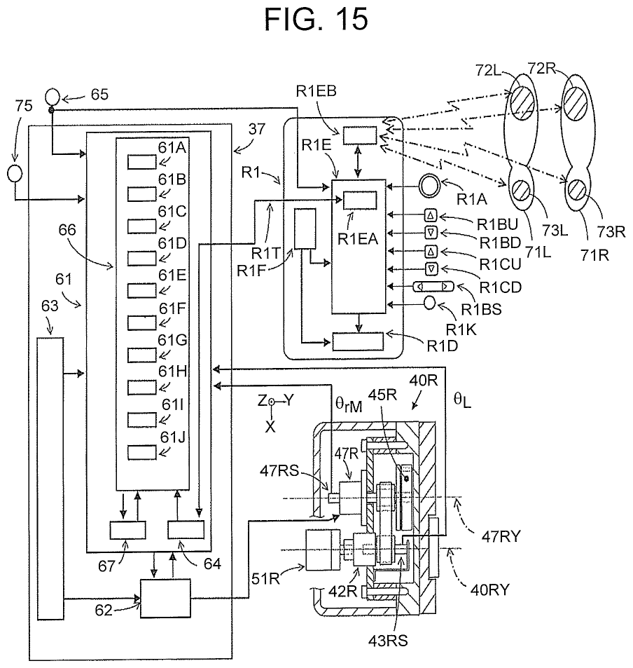

Based on detection signals from the load detection means 72L, 72R, 73L, 73R, when the person being assisted is not holding baggage, a controller 61 (see FIG. 15) can detect a person-being-assisted mass that is the mass of the person being assisted or a person-being-assisted weight that is the weight of the person being assisted. Moreover, based on detection signals from the load detection means 72L, 72R, 73L, 73R, when the person being assisted is holding baggage, the controller 61 (FIG. 15) can detect a combined mass that is the total mass of the person being assisted and the baggage or a combined weight that is the total weight of the person being assisted and the baggage. Then, based on the combined mass or the combined weight and on the person-being-assisted mass or the person-being-assisted weight, the controller 61 can detect a baggage mass that is the mass of the baggage or a baggage weight that is the weight of the baggage, and further obtains a load-related amount based on the baggage mass or the baggage weight (obtains an uncorrected baggage mass or baggage weight, or a corrected baggage mass or baggage weight).

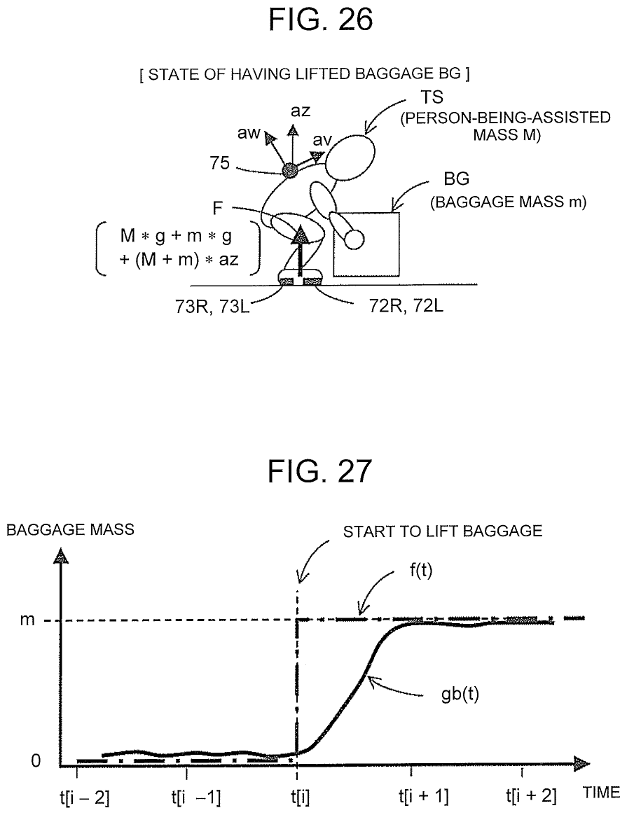

The acceleration rate detection means 75 is an acceleration rate sensor, for example, and is provided in the backpack 37 and detects a body motion acceleration rate that is an acceleration rate of a motion of a part of the body of the person being assisted (in this case, the upper body (upper-half body) of the person being assisted). As the backpack 37 is fixed to the back of the person being assisted, the acceleration rate detection means 75 detects a body motion acceleration rate av (see FIG. 25 and FIG. 26) in a parallel-to-spine direction along the surface of the back of the person being assisted, and a body motion acceleration rate aw (see FIG. 25 and FIG. 26) in an orthogonal-to-back direction orthogonal to the surface of the back of the person being assisted. Based on the body motion acceleration rates av, aw, etc., the controller 61 can obtain a body motion acceleration rate az (see FIG. 26) of a vertical direction component.

As will be described later, the controller 61 corrects the baggage mass (baggage weight) obtained based on detection signals from the load detection means 72L, 72R, 73L, 73R by using the body motion acceleration rate az obtained based on a detection signal from the acceleration rate detection means 75, and thereby obtains a load-related amount (in this case, a corrected baggage mass or baggage weight).

The body gear 2 (see FIG. 3) is worn at least around the hips of the person being assisted. The right actuator unit 4R and the left actuator unit 4L (see FIG. 4) are attached to the body gear 2 and worn on the thighs of the person being assisted, to assist the person being assisted in moving his or her thighs relative to the hips or moving his or her hips relative to the thighs. In the following, the body gear 2 and the actuator unit 4 will be described in this order.

As shown in FIG. 2 and FIG. 3, the body gear 2 has: the hip support 10 worn around the hips of the person being assisted; the jacket 20 worn around the shoulders and the chest of the person being assisted; the frame 30 to which the jacket 20 is connected; and the backpack 37 and the cushion 37G both mounted on the frame 30. The frame 30 is disposed on the back and around the hips of the person being assisted.

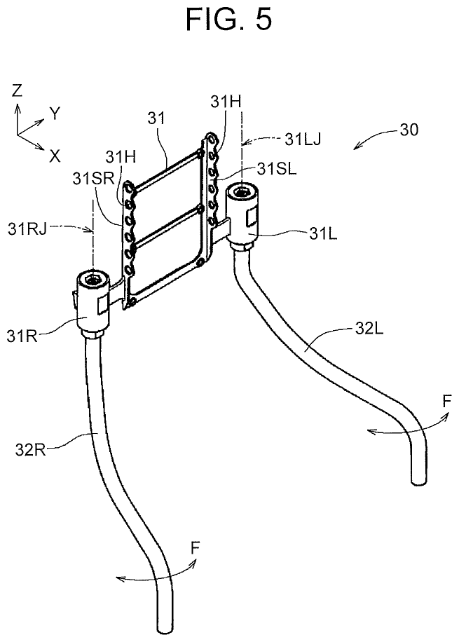

As shown in FIG. 2 and FIG. 5, the frame 30 has a main frame 31, a right sub-frame 32R, a left sub-frame 32L, etc. As shown in FIG. 5, the main frame 31 has support bodies 31SR, 31SL each having a plurality of belt connection holes 31H disposed in an up-down direction, and a connector 31R and a connector 31L. The right sub-frame 32R is connected at one end (upper end) to the connector 31R, and the left sub-frame 32L is connected at one end (upper end) to the connector 31L. The right sub-frame 32R and the left sub-frame 32L have elasticity, and the interval between lower ends thereof in a right-left direction is adjusted, along with the hip support 10, according to the hip width of the person being assisted (see FIG. 1).

As shown in FIG. 1, the right sub-frame 32R is connected (fixed) at a lower end to a connector 41RS of the right actuator unit 4R, and the left sub-frame 32L is connected (fixed) at a lower end to a connector 41LS of the left actuator unit 4L.

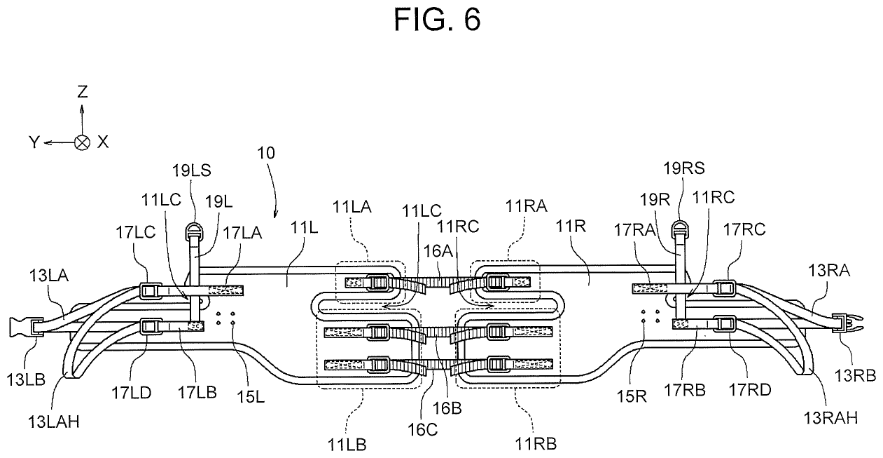

As shown in FIG. 3 and FIG. 6, the hip support 10 has a right hip-worn part 11R worn around the hip on the right side of the person being assisted, and a left hip-worn part 11L worn around the hip on the left side of the person being assisted. As shown in FIG. 6, the right hip-worn part 11R and the left hip-worn part 11L are connected to each other by a back hip belt 16A, an upper buttock belt 16B, and a lower buttock belt 16C.

As shown in FIG. 1 and FIG. 2, the hip support 10 has a coupling belt 19R with a coupling ring 19RS that is coupled to a coupling portion 29RS of the jacket 20, and a coupling belt 19L with a coupling ring 19LS that is coupled to a coupling portion 29LS of the jacket 20. As shown in FIG. 2, the hip support 10 further has mounting holes 15R used to connect the hip support 10 to a coupling portion 4ORS of the right actuator unit 4R, and mounting holes 15L used to connect the hip support 10 to a coupling portion 40LS of the left actuator unit 4L, respectively at positions at which the hip support 10 intersects with an imaginary turning axis 15Y.

As shown in FIG. 6, a cutout 11RC is formed in the right hip-worn part 11R, at a position corresponding to the back side of the person being assisted, and the right hip-worn part 11R is thereby divided into a right hip portion 11RA and a right buttock portion 11RB. A cutout 11LC is formed in the left hip-worn part 11L, at a position corresponding to the back side of the person being assisted, and the left hip-worn part 11L is thereby divided into a left hip portion 11LA and a left buttock portion 11LB.

As shown in FIG. 6, the hip support 10 has various length-adjustable belts etc. that allow the hip support 10 to closely fit around the hips of the person being assisted without becoming displaced, including a right hip fastening belt 13RA, a hip belt retaining member 13RB (hip buckle), a left hip fastening belt 13LA, a hip belt retaining member 13LB (hip buckle), a right upper pelvis belt 17RA, a right lower pelvis belt 17RB, a left upper pelvis belt 17LA, a left lower pelvis belt 17LB, a right upper belt retaining member 17RC (right upper adjuster), a right lower belt retaining member 17RD (right lower adjuster), a tensioning portion 13RAH, a left upper belt retaining member 17LC (left upper adjuster), a left lower belt retaining member 17LD (left lower adjuster), and a tensioning portion 13LAH.

As shown in FIG. 1 and FIG. 3, the backpack 37 is mounted on the main frame 31 that forms an upper end part of the frame 30. As shown in FIG. 3, a right shoulder belt 24R, a right side belt 25R, a left shoulder belt 24L, and a left side belt 25L of the jacket 20 are connected to the main frame 31 or the backpack 37.

As shown in FIG. 1 to FIG. 3, the backpack 37 has a simple box shape, and houses a controller, a power source unit, communication means, etc. As shown in FIG. 3, the support bodies 31SR, 31SL each having the belt connection holes 31H (corresponding to belt connectors) disposed in the up-down direction are provided in the main frame 31, at positions facing the back sides of both shoulders of the person being assisted. The belt connection holes 31H (belt connectors) are provided to allow the position in a height direction of the jacket 20 relative to the frame 30 to be adjusted according to the physical size of the person being assisted. Thus, the height of the jacket 20 can be adjusted to an appropriate position according to the physical size of the person being assisted.

Even when the upper body of the person being assisted leans forward, the actuator unit (4R, 4L) that outputs an assisting torque can be appropriately supported if the cushion 37G (or a back support 37C) that comes into contact with the back of the person being assisted is elongated in a direction from the shoulders to the hips of the person being assisted. Moreover, even when the upper body of the person being assisted leans rightward or leftward, the actuator unit (4R, 4L) that outputs an assisting torque can be more appropriately supported (supported with higher rigidity) as the cushion 37G (or the back support 37C) comes into contact with the person being assisted, centered at a bend in his or her back.

As shown in FIG. 3, a belt connector 24RS of the right shoulder belt 24R is connected to one of the belt connection holes 31H (belt connectors) of the support body 31SR. Similarly, as shown in FIG. 3, a belt connector 24LS of the left shoulder belt 24L is connected to one of the belt connection holes 31H (belt connectors) of the support body 31SL. Alternatively, the support bodies 31SR, 31SL may be provided in the backpack 37.

As shown in FIG. 3, belt connectors 37FR, 37FL are respectively provided on right and left sides of a lower end of the backpack 37. As shown in FIG. 3, a belt connector 25RS of the right side belt 25R is connected to the belt connector 37FR. Similarly, as shown in FIG. 3, a belt connector 25LS of the left side belt 25L is connected to the belt connector 37FL. Alternatively, the belt connectors 37FR, 37FL may be provided in the main frame 31.

As shown in FIG. 3, the jacket 20 has a right chest-worn part 21R worn on the right-side chest of the person being assisted, and a left chest-worn part 21L worn on the left-side chest of the person being assisted. The right chest-worn part 21R is connected to the left chest-worn part 21L, for example, by a touch-and-close fastener 21F and a buckle 21B, which allows the person being assisted to easily put on and take off the jacket 20.

As shown in FIG. 3, the right chest-worn part 21R has the right shoulder belt 24R and the belt connector 24RS connected to the belt connection hole 31H of the main frame 31 (or the backpack 37), and the right side belt 25R and the belt connector 25RS connected to the belt connector 37FR of the backpack 37 (or the main frame 31). As shown in FIG. 3, the left chest-worn part 21L has the left shoulder belt 24L and the belt connector 24LS connected to the main frame 31 (or the backpack 37), and the left side belt 25L and the belt connector 25LS connected to the belt connector 37FL of the backpack 37 (or the main frame 31). As shown in FIG. 3, the right chest-worn part 21R has a coupling belt 29R and the coupling portion 29RS by which the right chest-worn part 21R is coupled to the right hip-worn part 11R, and the left chest-worn part 21L has a coupling belt 29L and the coupling portion 29LS by which the left chest-worn part 21L is coupled to the left hip-worn part 11L.

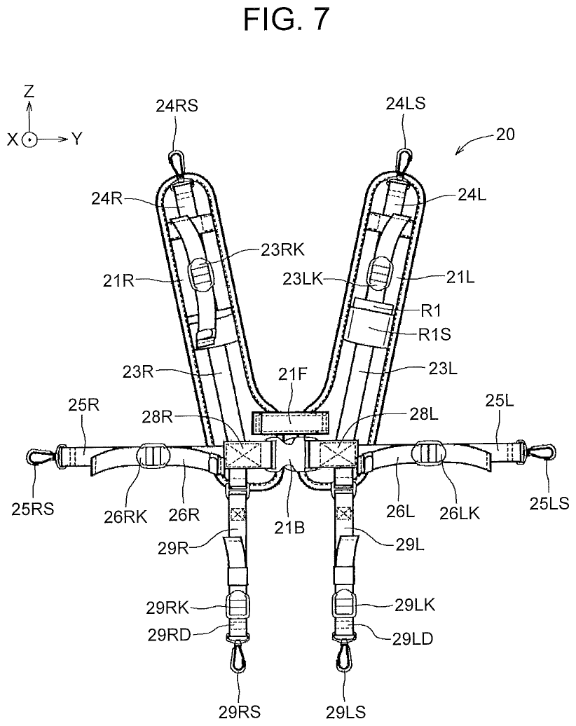

As shown in FIG. 7, the jacket 20 has various length-adjustable belts etc. that allow the jacket 20 to closely fit around the chest of the person being assisted without becoming displaced, including a fixing portion 28R, a fixing portion 28L, a right shoulder belt 23R, a right shoulder belt retaining member 23RK (right shoulder adjuster), a left shoulder belt 23L, a left shoulder belt retaining member 23LK (left shoulder adjuster), a right side belt 26R, a right side belt retaining member 26RK (right side adjuster), a left side belt 26L, and a left side belt retaining member 26LK (left side adjuster).

FIG. 4 shows the load detection units 71L, 71R and an external appearance of the right actuator unit 4R and the left actuator unit 4L shown in FIG. 2. Since the left actuator unit 4L is symmetrical with the right actuator unit 4R in the right-left direction, the description of the left actuator unit 4L will be omitted from the subsequent description.

As shown in FIG. 4, the right actuator unit 4R has a torque generation part 40R and an output link 50R that is a torque transmission part. The torque generation part 40R has an actuator base 41R, a cover 41RB, and a coupling base 4AR. As shown in FIG. 4, the output link 50R is worn on a body part to be assisted (in this case, the thigh) and turns around a joint (in this case, the hip joint) of the body part to be assisted (in this case, the thigh). An assisting torque that assists turning of the body part to be assisted through the output link 50R is generated by an electric motor (actuator) inside the torque generation part 40R.

The output link 50R has an assist arm 51R (corresponding to a first link), a second link 52R, a third link 53R, and a thigh-worn part 54R (corresponding to a body holding part). The assist arm 51R is turned around a turning axis 40RY by a combined torque that combines the assisting torque generated by the electric motor inside the torque generation part 40R and a person being assisted-exerted torque resulting from the person being assisted moving his or her thigh. The second link 52R is connected at one end to a leading end of the assist arm 51R so as to be able to turn around a turning axis 51RJ, and the third link 53R is connected at one end to the other end of the second link 52R so as to be able to turn around a turning axis 52RJ. The thigh-worn part 54R is connected to the other end of the third link 53R through a third joint 53RS (in this case, a spherical joint).

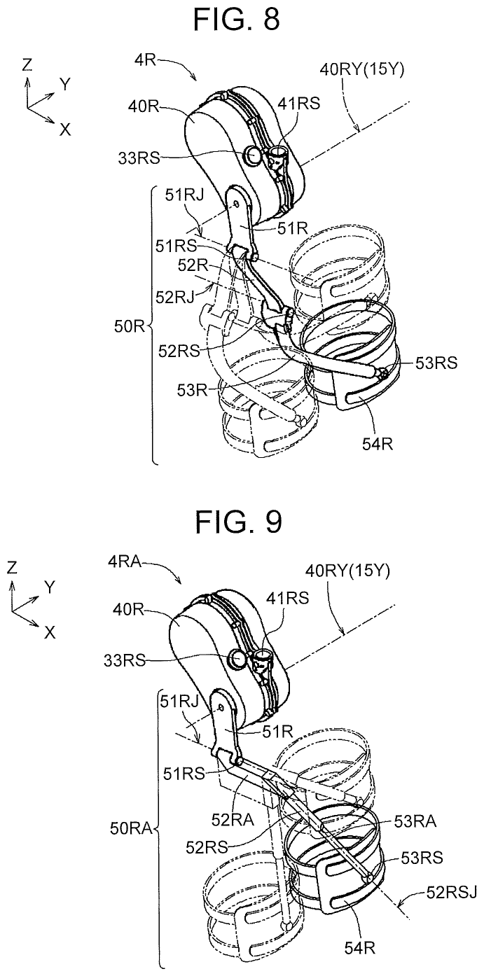

Next, the link mechanism of the right actuator unit 4R will be described in detail using FIG. 4, FIG. 8, and FIG. 9. As examples of the link mechanism, the example of the output link 50R shown in FIG. 8 and the example of an output link 50RA shown in FIG. 9 will be described.

The output link 50R shown in FIG. 8 is composed of a plurality of coupling members, namely, the assist arm 51R (corresponding to the first link), the second link 52R, the third link 53R, and the thigh-worn part 54R (corresponding to the body holding part) that are coupled to one another by joints.

The second link 52R is coupled at the one end to the leading end of the assist arm 51R by a first joint 51RS so as to be able to turn around the turning axis 51RJ. The first joint 51RS has a coupling structure with one degree of freedom that allows the second link 52R to turn around the turning axis 51RJ relative to the assist arm 51R.

The third link 53R is coupled at the one end to the other end of the second link 52R by a second joint 52RS so as to be able to turn around the turning axis 52RJ. The second joint 52RS has a coupling structure with one degree of freedom that allows the third link 53R to turn around the turning axis 52RJ relative to the second link 52R.

The third link 53R is coupled at the other end to the thigh-worn part 54R by the third joint 53RS (e.g., a spherical joint). Accordingly, the third joint 53RS between the third link and the thigh-worn part 54R (body holding part) has a coupling structure with three degrees of freedom. Thus, the total number of degrees of freedom of the output link 50R shown in FIG. 8 is: 1+1+3=5.

However, the total number of degrees of freedom of the output link 50R may be any number not smaller than three. For example, the third joint 53RS may be configured so as to allow the thigh-worn part 54R to turn around a turning axis relative to the other end of the third link 53R (the degree of freedom=1). Thus, with the first joint 51RS and the second joint 52RS each having one degree of freedom, the total number of degrees of freedom of the output link in this case is: 1+1+1=3. It is preferable that a stopper that limits the range of turning of the second link or the third link be provided.

The output link 50RA shown in FIG. 9 is composed of a plurality of coupling members, namely, the assist arm 51R (corresponding to the first link), a second link 52RA (and the second joint 52RS), a third link 53RA, and the thigh-worn part 54R (corresponding to the body holding part) that are coupled to one another by joints.

The second link 52RA is coupled at an end to the leading end of the assist arm 51R by the first joint 51RS so as to be able to turn around the turning axis 51RJ. The first joint 51RS has a coupling structure with one degree of freedom that allows the second link 52RA to turn around the turning axis 51RJ relative to the assist arm 51R.

The second link 52RA and the second joint 52RS are integrated with each other, and the third link 53RA capable of sliding back and forth along a sliding axis 52RSJ that is an axis in a longitudinal direction is coupled at one end to the second link 52RA by the second joint 52RS. The second joint 52RS has a coupling structure with one degree of freedom that allows the third link 53RA to slide along the sliding axis 52RSJ relative to the second link 52RA.

The third link 53RA is coupled at the other end to the thigh-worn part 54R by the third joint 53RS (e.g., a spherical joint). Accordingly, the third joint 53RS between the third link 53RA and the thigh-worn part 54R (body holding part) has a coupling structure with three degrees of freedom. Thus, the total number of degrees of freedom of the output link 50RA shown in FIG. 9 is: 1+1+3=5.

Since the total number of degrees of freedom may be any number not smaller than three, the third joint 53RS may have a coupling structure with one degree of freedom that allows the thigh-worn part 54R to turn around the turning axis. It is preferable that a stopper that limits the range of turning of the second link 52RA or the range of sliding of the third link 53RA be provided.

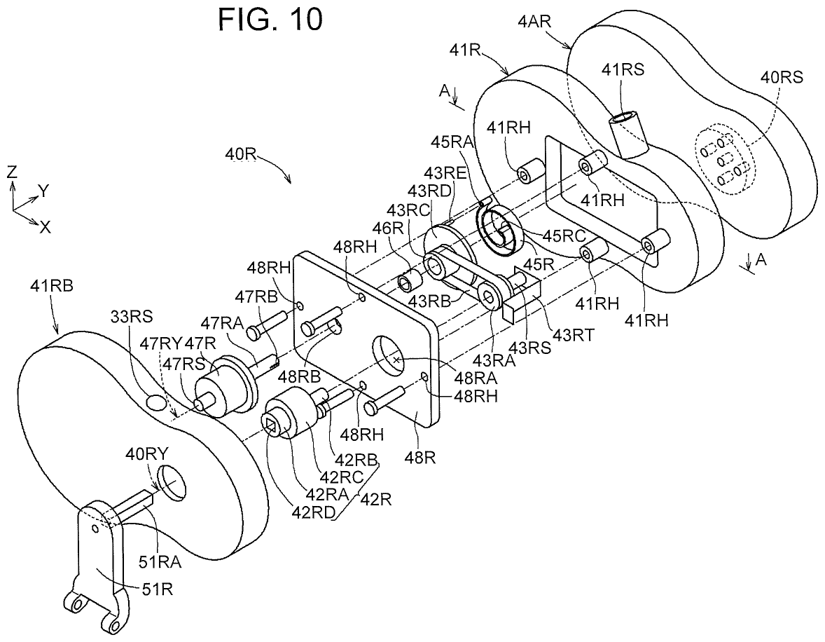

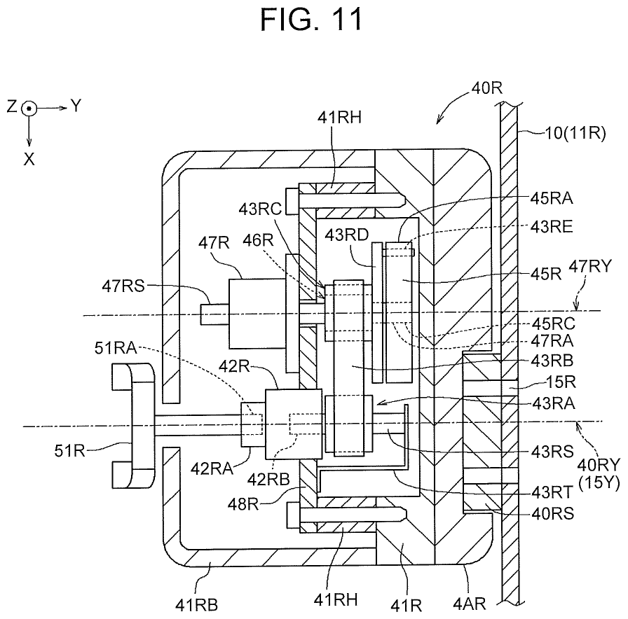

Next, members housed inside the cover 41RB of the torque generation part 40R (see FIG. 4) will be described by using FIG. 10 and FIG. 11. FIG. 11 is a sectional view taken along line A-A in FIG. 10. As shown in FIG. 10 and FIG. 11, the cover 41RB houses a speed reducer 42R, a pulley 43RA, a transmission belt 43RB, a pulley 43RC having a flange 43RD, a spiral spring 45R, a bearing 46R, an electric motor 47R (actuator), a sub-frame 48R, etc. The assist arm 51R having a shaft 51RA is disposed on an outer side of the cover 41RB.

Outlet ports 33RS, 33LS (connection ports) for an actuator driving cable, a control cable, and a communication cable are provided in the actuator units (4R, 4L) at portions near the frame 30. The cables (not shown) connected to the cable outlet ports 33RS, 33LS are disposed along the frame 30 and connected to the backpack 37.

As shown in FIG. 11, the torque generation part 40R has the actuator base 41R on which the sub-frame 48R having the electric motor 47R etc. installed thereon is mounted, the cover 41RB mounted on one side of the actuator base 41R, and the coupling base 4AR mounted on the other side of the actuator base 41R. The coupling portion 40RS capable of turning around the turning axis 40RY is provided on the coupling base 4AR.

As shown in FIG. 10 and FIG. 11, output link turning angle detection means 43RS (turning angle sensor etc.) that detects a turning angle of the assist arm 51R relative to the actuator base 41R is connected to the pulley 43RA that is connected to a speed increasing shaft 42RB of the speed reducer 42R. The output link turning angle detection means 43RS is, for example, an encoder or an angle sensor, and outputs a detection signal according to the rotation angle to the controller 61 (see FIG. 15). The electric motor 47R is provided with motor rotation angle detection means 47RS capable of detecting a rotation angle of a motor shaft (corresponding to an output shaft). The motor rotation angle detection means 47RS is, for example, an encoder or an angle sensor, and outputs a detection signal according to the rotation angle to the controller 61 (see FIG. 15).

As shown in FIG. 10, the sub-frame 48R has a through-hole 48RA in which a speed reducer housing 42RC of the speed reducer 42R is fixed, and a through-hole 48RB through which an output shaft 47RA of the electric motor 47R is passed. The shaft 51RA of the assist arm 51R is fitted in a hole 42RD of a speed reducing shaft 42RA of the speed reducer 42R, and the speed reducer housing 42RC of the speed reducer 42R is fixed to the through-hole 48RA of the sub-frame 48R. Thus, the assist arm 51R is supported so as to be able to turn around the turning axis 40RY relative to the actuator base 41R, and turns integrally with the speed reducing shaft 42RA. The electric motor 47R is fixed to the sub-frame 48R, and the output shaft 47RA is passed through the through-hole 48RB of the sub-frame 48R. The sub-frame 48R is fixed to mounting portions 41RH of the actuator base 41R with fastening members, such as bolts.

As shown in FIG. 10, the pulley 43RA is connected to the speed increasing shaft 42RB of the speed reducer 42R, and the output link turning angle detection means 43RS is connected to the pulley 43RA. A support member 43RT fixed to the sub-frame 48R is connected to the output link turning angle detection means 43RS. Thus, the output link turning angle detection means 43RS can detect the turning angle of the speed increasing shaft 42RB relative to the sub-frame 48R (i.e., relative to the actuator base 41R). The turning angle of the assist arm 51R is a turning angle having been increased by the speed increasing shaft 42RB of the speed reducer 42R, and therefore the output link turning angle detection means 43RS and the controller can detect the turning angle of the assist arm 51R with higher resolution. By detecting the turning angle of the output link with higher resolution, the controller can execute control with higher accuracy. The shaft 51RA of the assist arm 51R, the speed reducer 42R, the pulley 43RA, and the output link turning angle detection means 43RS are disposed coaxially along the turning axis 40RY.

The speed reducer 42R has a set speed reduction ratio n (1<n), and turns the speed increasing shaft 42RB by a turning angle nθ when the speed reducing shaft 42RA is turned by a turning angle θ. When the speed increasing shaft 42RB is turned by the turning angle nθ, the speed reducer 42R turns the speed reducing shaft 42RA by the turning angle θ. The transmission belt 43RB is wrapped around the pulley 43RA to which the speed increasing shaft 42RB of the speed reducer 42R is connected and around the pulley 43RC. Accordingly, the person being assisted-exerted torque from the assist arm 51R is transmitted to the pulley 43RC through the speed increasing shaft 42RB, and the assisting torque from the electric motor 47R is transmitted to the speed increasing shaft 42RB through the spiral spring 45R and the pulley 43RC.

The spiral spring 45R has a spring constant Ks, and has a shape of a spiral with an inner end 45RC on a center side and an outer end 45RA on an outer circumferential side. The inner end 45RC of the spiral spring 45R is fitted in a groove 47RB formed in the output shaft 47RA of the electric motor 47R. The outer end 45RA of the spiral spring 45R is wound into a cylindrical shape. A transmission shaft 43RE provided on the flange 43RD of the pulley 43RC is fitted in the outer end 45RA, and the outer end 45RA is supported by the transmission shaft 43RE. (The pulley 43RC is integrated with the flange 43RD and the transmission shaft 43RE). The pulley 43RC is supported so as to be able to turn around a turning axis 47RY, and the transmission shaft 43RE protruding toward the spiral spring 45R is provided near an outer circumferential edge of the flange 43RD integrated with the pulley 43RC. The transmission shaft 43RE is fitted in the outer end 45RA of the spiral spring 45R, and moves the position of the outer end 45RA around the turning axis 47RY. A bearing 46R is provided between the output shaft 47RA of the electric motor 47R and the pulley 43RC. Thus, the output shaft 47RA is not fixed to the pulley 43RC, and the output shaft 47RA can rotate independently of the pulley 43RC. The pulley 43RC is driven to rotate by the electric motor 47R through the spiral spring 45R. In the configuration having been described above, the output shaft 47RA of the electric motor 47R, the bearing 46R, the pulley 43RC having the flange 43RD, and the spiral spring 45R are disposed coaxially along the turning axis 47RY.

The spiral spring 45R accumulates the assisting torque that is transmitted from the electric motor 47R and the person being assisted-exerted torque that results from the person being assisted moving his or her thigh and is transmitted via the assist arm 51R, the speed reducer 42R, the pulley 43RA, and the pulley 43RC, and thus accumulates the combined torque combining the assisting torque and the person being assisted-exerted torque. The combined torque accumulated in the spiral spring 45R turns the assist arm 51R through the pulley 43RC, the pulley 43RA, and the speed reducer 42R. In the configuration having been described above, the output shaft 47RA of the electric motor 47R is connected to the output link (in the case of FIG. 10, the assist arm 51R) through the speed reducer 42R that reduces the rotation angle of the output shaft 47RA.

The combined torque accumulated in the spiral spring 45R is obtained based on an amount of change in angle from a no-load state and the spring constant. For example, the combined torque is obtained based on the turning angle of the assist arm 51R (obtained by the output link turning angle detection means 43RS), the rotation angle of the output shaft 47RA of the electric motor 47R (obtained by the motor rotation angle detection means 47RS), and the spring constant Ks of the spiral spring 45R. The person being assisted-exerted torque is extracted from the obtained combined torque, and an assisting torque according to this person being assisted-exerted torque is output from the electric motor.

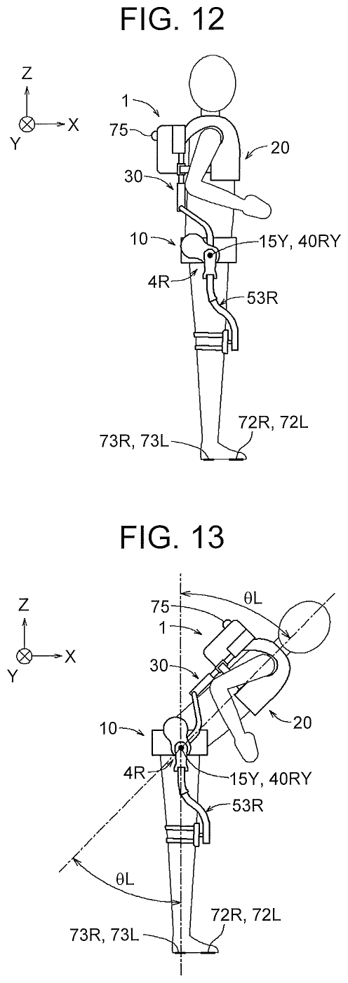

As shown in FIG. 11, the torque generation part 40R of the right actuator unit has the coupling portion 4ORS capable of turning around the turning axis 40RY (i.e., the imaginary turning axis 15Y). As shown in FIG. 2 and FIG. 1, the coupling portion 4ORS is coupled (fixed) through the mounting holes 15R of the hip support 10 with coupling members, such as bolts. As shown in FIG. 2 and FIG. 1, the right sub-frame 32R of the frame 30 is connected (fixed) at the lower end to the connector 41RS of the right actuator unit 4R. Similarly, the coupling portion 40LS of a torque generation part 40L of the left actuator unit is coupled (fixed) through the mounting holes 15L of the hip support 10 with coupling members, such as bolts, and the left sub-frame 32L of the frame 30 is connected (fixed) at the lower end to the connector 41LS of the left actuator unit 4L. Thus, in FIG. 2, the hip support 10 and the frame 30 are fixed to the torque generation part 40R of the right actuator unit 4R, and the hip support 10 and the frame 30 are fixed to the torque generation part 40L of the left actuator unit 4L. The right actuator unit 4R, the left actuator unit 4L, and the frame 30 are integrated with one another, and are capable of turning relative to the hip support 10 by the coupling portions 40R5, 40LS (see FIG. 2) capable of turning around the imaginary turning axis 15Y (see FIG. 12 and FIG. 13).

As has been described above, the controller 61 can detect the rotation angle from a no-load state and the rotation direction of the spiral spring 45R based on a detection signal from the output link turning angle detection means 43RS and a detection signal from the motor rotation angle detection means 47RS, and can detect a torque (combined torque) by these rotation angle and rotation direction and the spring constant of the spiral spring 45R. In this case, the output link turning angle detection means 43RS, the motor rotation angle detection means 47RS, and the spiral spring 45R correspond to torque detection means, and the controller 61 can detect a torque-related amount (in this case, a combined torque) related with the torque based on the forward leaning angle detected by the output link turning angle detection means 43RS (corresponding to angle detection means).

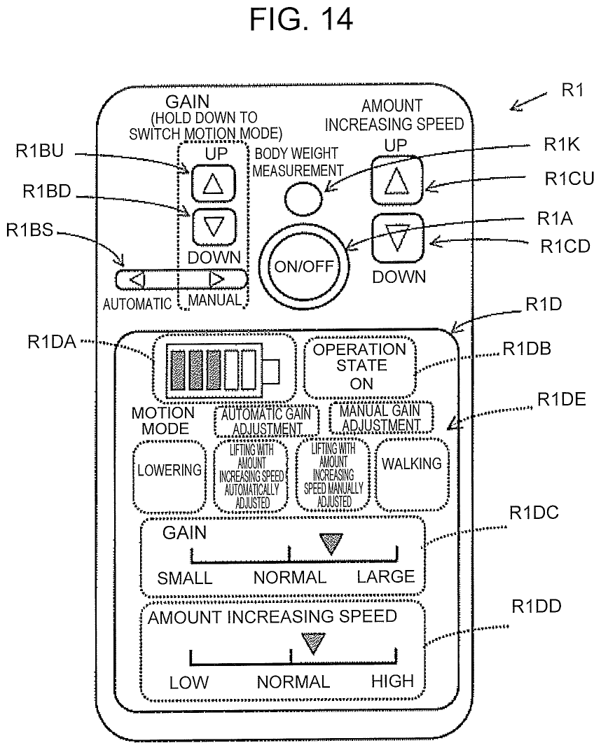

Next, the manipulation unit R1 that allows the person being assisted to easily make adjustments etc. to the assisting state of the assist device 1 will be described by using FIG. 14 to FIG. 16. As shown in FIG. 15, the manipulation unit R1 is connected to the controller 61 inside the backpack 37 (see FIG. 1) through a wired or wireless communication line R1T. A controller R1E of the manipulation unit R1 is capable of transmitting and receiving information to and from the controller 61 through communication means R1EA, and the controller 61 is capable of transmitting and receiving information to and from the controller R1E inside the manipulation unit R1 through communication means 64. The controller R1E of the manipulation unit R1 can receive detection signals from the load detection means 72L, 72R, 73L, 73R through second communication means R1EB (e.g., wireless communication such as Bluetooth®, or intra-body communication). As shown in FIG. 1, when not manipulating the manipulation unit R1, the person being assisted can house the manipulation unit R1, for example, in the housing part R1S that is a pocket or the like provided in the jacket 20 (see FIG. 1).

As shown in FIG. 14, the manipulation unit R1 has a main manipulation part R1A, an automatic-manual gain adjustment switching manipulation part RIBS, a gain upward manipulation part R1BU, a gain downward manipulation part R1BD, an amount increasing speed upward manipulation part R1CU, an amount increasing speed downward manipulation part R1CD, a body weight measurement manipulation part R1K, a display part R1D, etc. The gain upward manipulation part R1BU and the gain downward manipulation part R1BD correspond to gain changing means, and the amount increasing speed upward manipulation part R1CU and the amount increasing speed downward manipulation part R1CD correspond to amount increasing speed changing means. As shown in FIG. 15, the controller R1E, a manipulation unit power source R1F, etc. are provided inside the manipulation unit R1. To prevent an accidental manipulation while the manipulation unit R1 is housed inside the housing part R1S (see FIG. 1), it is preferable that the main manipulation part R1A, the gain upward manipulation part R1BU, the gain downward manipulation part R1BD, the amount increasing speed upward manipulation part R1CU, the amount increasing speed downward manipulation part R1CD, the automatic-manual gain adjustment switching manipulation part RIBS, and the body weight measurement manipulation part R1K do not protrude from a plane in which these parts are disposed.

The main manipulation part R1A is a switch that is manipulated by the person being assisted to start and stop assisting control executed by the assist device 1. As shown in FIG. 15, a main power switch 65 used to start and stop the (entire) assist device 1 itself is provided, for example, in the backpack 37. When the main power switch 65 is manipulated to the ON side, the controller 61 and the controller R1E are started, and when the main power switch 65 is manipulated to the OFF side, the operation of the controller 61 and the controller R1E is stopped. As shown in FIG. 14, whether the current operation state of the assist device is ON (in operation) or OFF (shut-down) is displayed, for example, in a display area R1DB of the display part IUD of the manipulation unit R1.

The automatic-manual gain adjustment switching manipulation part RIBS is a switch that is used to switch between automatically adjusting the gain in (the amount of) the assisting torque and manually adjusting this gain by the person being assisted. When the automatic-manual gain adjustment switching manipulation part RIBS is set to the “Automatic” side, manipulation of the gain upward manipulation part R1BU and the gain downward manipulation part R1BD is disabled. The controller 61 detects the mass (or weight) of baggage that the person being assisted is holding, and automatically adjusts the amount of assisting torque according to the detected mass (or weight) of the baggage. On the other hand, when the automatic-manual gain adjustment switching manipulation part RIBS is set to the “Manual” side, manipulation of the gain upward manipulation part R1BU and the gain downward manipulation part R1BD is enabled. The controller 61 changes the amount of assisting torque according to manipulation of the gain upward manipulation part R1BU and the gain downward manipulation part R1BD. To detect the mass (or weight) of baggage, it is necessary to measure the mass (or weight) of the person being assisted. As will be described later, the body weight measurement manipulation part R1K is used by the person being assisted to have his or her own mass measured by the controller. In the case of automatic gain adjustment, the gain may be adjusted by using a learning model created by machine learning (a neural network etc.). (Storage means for learning may be provided inside the controller 61, and the controller 61 may learn by performing a learning operation, with a learning model of another assist device stored by using the storage means, the communication means 64, etc.)

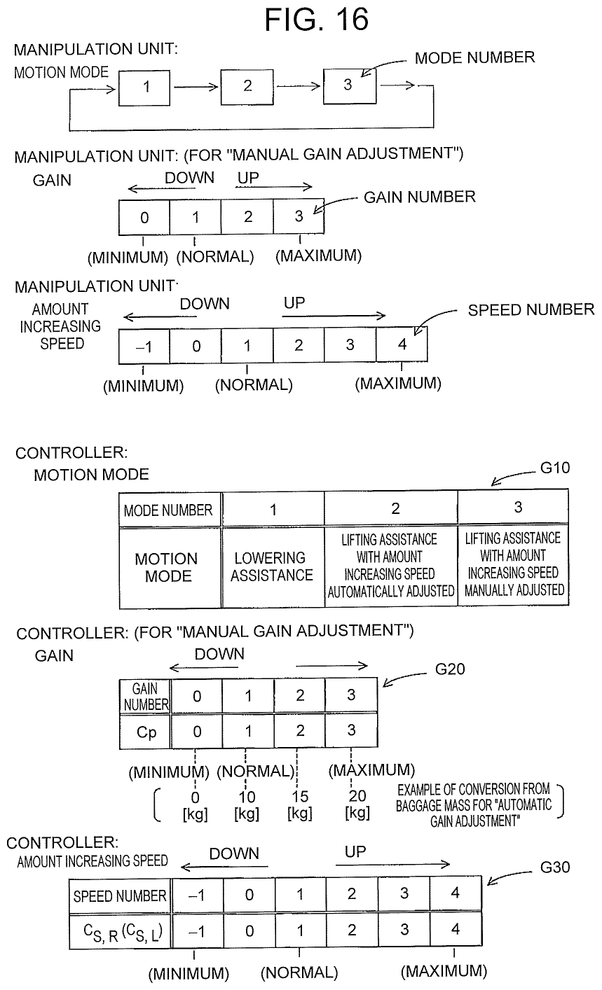

The gain upward manipulation part R1BU and the gain downward manipulation part R1BD are switches that are manipulated by the person being assisted, while the automatic-manual gain adjustment switching manipulation part RIBS is set to the “Manual” side, to increase and decrease the gain in the assisting torque generated by the assist device. For example, as shown in “Manipulation Unit: Gain (for “Manual Gain Adjustment”)” in FIG. 16, the controller R1E increases a stored gain number by one each time the gain upward manipulation part R1BU is manipulated, and decreases the gain number by one each time the gain downward manipulation part R1BD is manipulated. While FIG. 16 shows an example in which the gain number has four numbers from 0 to 3, the gain number is not limited to four numbers. As shown in FIG. 15, the controller R1E displays a content according to the current gain number, for example, in a display area R1DC of the display part IUD of the manipulation unit R1.

When the gain upward manipulation part R1BU is held down, for example, for 5 [sec] or longer, the gain upward manipulation part R1BU functions as a motion mode switch (regardless of switching between automatic and manual gain adjustment by the automatic-manual gain adjustment switching manipulation part RIBS). When the gain upward manipulation part R1BU is held down, the motion mode (mode number) switches sequentially from 1 (lowering assistance) to 2 (lifting assistance with the amount increasing speed automatically adjusted) to 3 (lifting assistance with the amount increasing speed manually adjusted), as shown in “Manipulation Unit: Motion Mode” in FIG. 16, each time the gain upward manipulation part R1BU is pressed. In this case, the gain upward manipulation part R1BU corresponds to motion switching means. As shown in FIG. 14, the controller R1E (see FIG. 15) displays a content according to the current motion mode, for example, in a display area RIDE of the display part IUD of the manipulation unit R1. “Walking” mode is a motion mode which cannot be specified through the gain upward manipulation part R1BU, and to which the motion mode switches automatically when the controller 61 recognizes that the person being assisted is “walking.”

The amount increasing speed upward manipulation part R1CU and the amount increasing speed downward manipulation part R1CD are switches that are manipulated by the person being assisted, while the motion mode is “lifting assistance with the amount increasing speed manually adjusted,” to increase and decrease the speed with which the amount of assisting torque generated by the assist device is increased. For example, as shown in “Manipulation Unit: Amount Increasing Speed” in FIG. 16, the controller R1E increases a stored speed number by one each time the amount increasing speed upward manipulation part R1CU is manipulated, and decreases the speed number by one each time the amount increasing speed downward manipulation part R1CD is manipulated. FIG. 16 shows an example in which the speed number has six numbers from −1 to 4, but the speed number is not limited to six numbers. As shown in FIG. 15, the controller R1E displays a content according to the current speed number, for example, in a display area R1DD (see FIG. 14) of the display part R1D of the manipulation unit R1.

The controller R1E of the manipulation unit R1 transmits manipulation information through the first communication means R1EA (see FIG. 15) at predetermined time intervals (e.g., several-millisecond to several-hundred-millisecond intervals) or each time one of the main manipulation part R1A, the gain upward manipulation part R1BU, the gain downward manipulation part R1BD, the amount increasing speed upward manipulation part R1CU, and the amount increasing speed downward manipulation part R1CD is manipulated. This manipulation information includes a stop or start command, the mode number, the gain number, information on automatic or manual gain adjustment from the automatic-manual gain adjustment switching manipulation part, information on a body weight measurement command from the body weight measurement manipulation part, a detection signal from the load detection means, the speed number, etc.

Upon receiving the manipulation information, the controller 61 of the backpack 37 stores the received manipulation information, and transmits, through the communication means 64 (see FIG. 15), response information including battery information showing a battery state of the power source unit 63 used to drive the assist device, assistance information showing an assisting state, etc. The battery information included in the response information includes the remaining battery power of the power source unit 63 etc., and the assistance information included in the response information includes, for example, error information showing contents of an abnormality if any abnormality with the assist device has been found. As shown in FIG. 15, the controller R1E displays the remaining battery power, for example, in a display area R1DA (see FIG. 14) of the display part RID of the manipulation unit R1, and if error information is included, displays the error information somewhere in the display part R1D.

Upon receiving the manipulation information from the controller R1E, the controller 61 (see FIG. 15) starts the assist device when the start command is included in the received manipulation information, and stops the assist device when the stop command is included in the received manipulation information. As shown in “Controller: Motion Mode” in FIG. 16, for example, the controller 61 stores the motion mode according to the received mode number. Further, as shown in “Controller: Gain” in FIG. 16, for example, the controller 61 stores the value (0 to 3) of a gain Cₚ according to the gain number, and stores a (right) amount increasing speed C_{s, R} (right speed number: −1 to 4) and a (left) amount increasing speed C_{s, L} (left speed number: −1 to 4) according to the speed number. The motion mode, the gain Cₚ, and the amount increasing speeds C_{s, R}, C_{s, L} are used in a processing procedure to be described later.

As has been described above, the person being assisted can easily make adjustments for obtaining a desired assisting state by manipulating the manipulation unit R1. Moreover, the person being assisted can easily learn the state of the assist device from the remaining battery power, the error information, etc. displayed in the display part R1D of the manipulation unit R1. The forms of the various pieces of information displayed in the display part RID are not limited to those in the example of FIG. 14.

As shown in FIG. 15, the controller 61 is housed inside the backpack 37. In the example shown in FIG. 15, the controller 61, a motor driver 62, the power source unit 63, etc. are housed inside the backpack 37. For example, the controller 61 has control means 66 (CPU) and storage means 67 (that stores a control program etc. and corresponds to a storage device). The controller 61 has an adjustment determination unit 61A, an input processing unit 61B, a torque change amount etc. calculation unit 61C, a motion type determination unit 61D, a selection unit 61E, a lowering assisting torque calculation unit 61F, a lifting assisting torque calculation unit 61G, a walking assisting torque calculation unit 61H, a control command value calculation unit 611, a load determination unit 61J, the communication means 64, etc. to be described later. The motor driver 62 is an electronic circuit that outputs a driving current for driving the electric motor 47R based on a control signal from the controller 61. The power source unit 63 is a lithium battery, for example, and supplies electricity to the controller 61 and the motor driver 62. The operation of the communication means 64 etc. will be described later. A detection signal from the acceleration rate detection means 75 is input into the controller 61.

The manipulation information from the manipulation unit R1, a detection signal from the motor rotation angle detection means 47RS (a detection signal according to an actual motor shaft angle θ_{rM} of the electric motor 47R), a detection signal from the output link turning angle detection means 43RS (a detection signal according to an actual link angle θ_{L} of the assist arm 51R), etc. are input into the controller 61. The controller 61 obtains a rotation angle of the electric motor 47R based on the input signals, and outputs a control signal according to the obtained rotation angle to the motor driver 62.

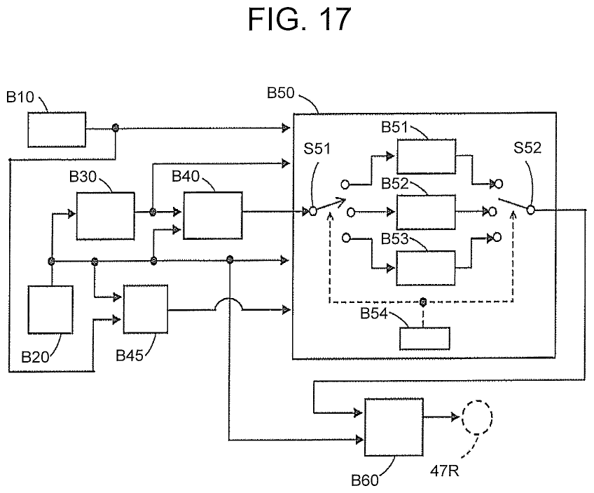

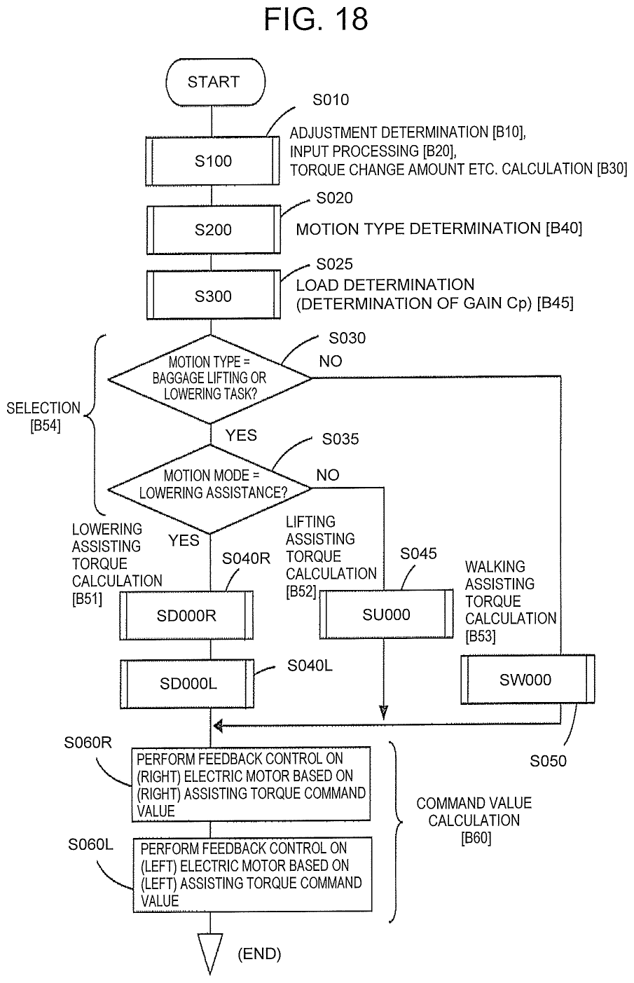

Next, the procedure of a process executed by the controller 61 will be described by using the flowchart shown in FIG. 18 and the control block shown in FIG. 17. The control block shown in FIG. 17 has an adjustment determination block B10, an input processing block B20, a torque change amount etc. calculation block B30, a motion type determination block B40, a load determination block B45, a selection block B54, a lowering assisting torque calculation block B51, a lifting assisting torque calculation block B52, a walking assisting torque calculation block B53, a control command value calculation block B60, switches S51, S52, etc. Contents of a process executed in each block will be described in accordance with the flowchart shown in FIG. 18.

The flowchart shown in FIG. 18 shows the procedure of the process of controlling the (right) actuator unit 4R and the (left) actuator unit 4L. The process shown in FIG. 18 is started at predetermined time intervals (e.g., several-millisecond intervals), and when this process is started, the controller 61 (corresponding to control means) moves to step S010. A processing program of the controller 61 and data, such as maps, are stored in the storage means 67 (corresponding to a storage device).

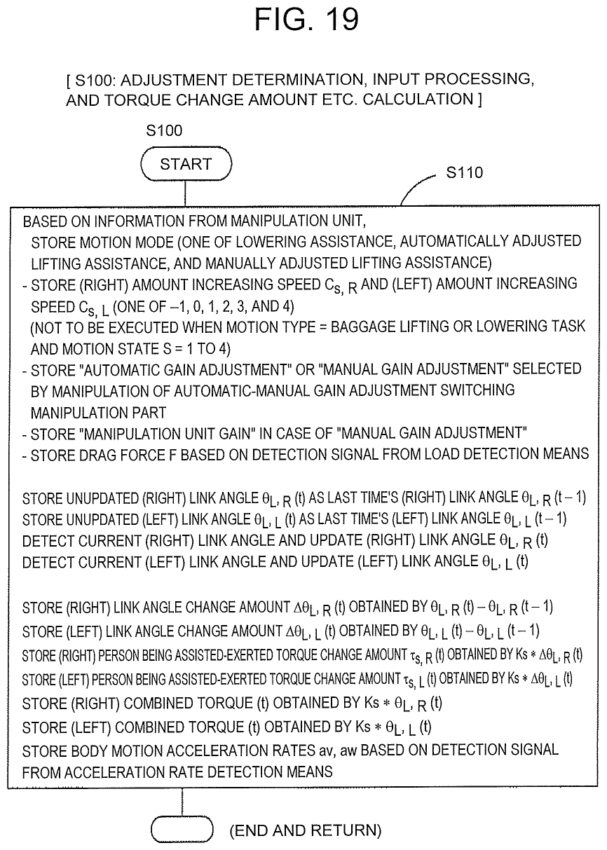

In step S010, the controller 61 executes a process S100 (see FIG. 19) and moves to step S020. The process S100 corresponds to the adjustment determination block B10, the input processing block B20, and the torque change amount etc. calculation block B30 shown in FIG. 17, and to the adjustment determination unit 61A, the input processing unit 61B, and the torque change amount etc. calculation unit 61C shown in FIG. 15. Details of the process S100 will be described later.

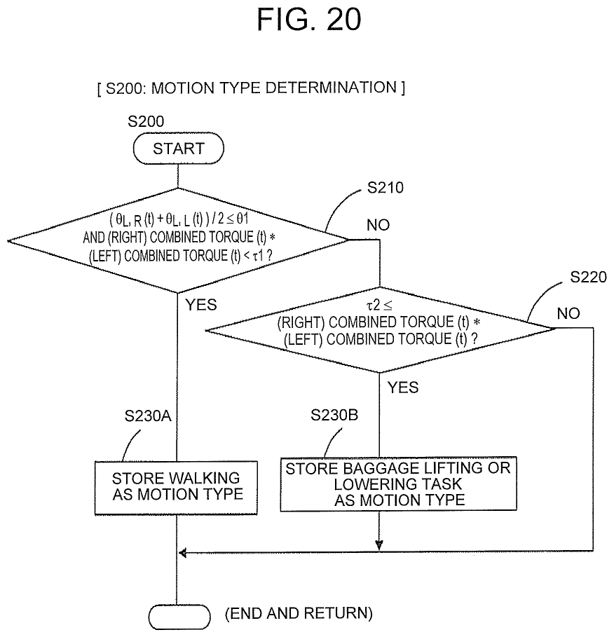

In step S020, the controller 61 executes a process S200 (see FIG. 20) and moves to step S025. The process S200 corresponds to the motion type determination block B40 shown in FIG. 17 and the motion type determination unit 61D shown in FIG. 15. Details of the process S200 will be described later.

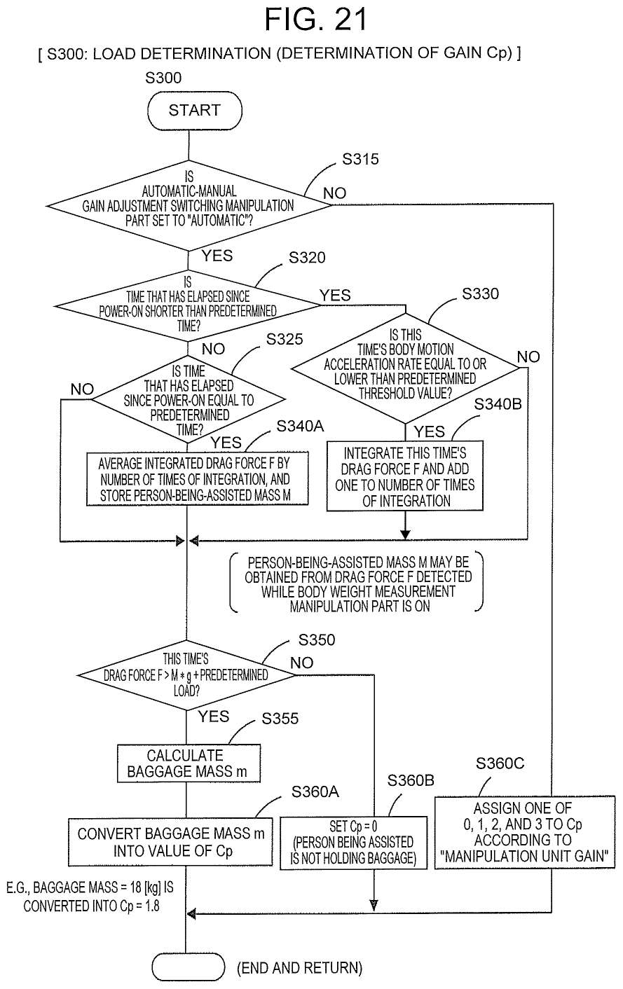

In step S025, the controller 61 executes a process S300 (see FIG. 21) and moves to step S030. The process S300 corresponds to the load determination block B45 shown in FIG. 17 and the load determination unit 61J shown in FIG. 15. The process S300 is a process of determining the value of the gain Cₚ, and details of the process S300 will be described later.

In step S030, the controller 61 determines whether or not the motion type determined in step S020 is a baggage lifting or lowering task, and moves to step S035 if the motion type is a baggage lifting or lowering task (Yes) and moves to step S050 if not (No).

When the controller 61 moves to step S035, the controller 61 determines whether or not the motion mode (the motion mode from the manipulation unit) in step S010 is lowering assistance, and moves to step S040R if the motion mode is lowering assistance (Yes) and moves to step S045 if not (No). The processes in steps S030 and S035 correspond to the selection block B54 shown in FIG. 17 and the selection unit 61E shown in FIG. 15.

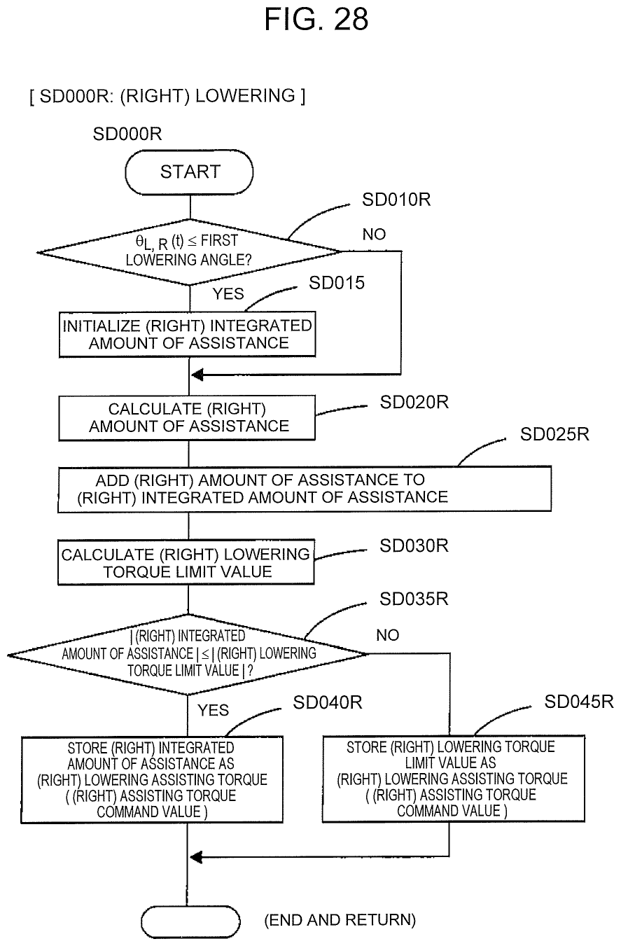

When the controller 61 moves to step S040R, the controller 61 executes a process SD000R (see FIG. 28) and moves to step S040L. The process SD000R is a process of obtaining a control command value for the (right) actuator unit 4R during a lowering motion, and corresponds to the lowering assisting torque calculation block B51 shown in FIG. 17 and the lowering assisting torque calculation unit 61F shown in FIG. 15. Details of the process SD000R will be described later.

In step S040L, the controller 61 executes a process SD000L (not shown) and moves to step S060R. The process SD000L is a process of obtaining a control command value for the (left) actuator unit 4L during a lowering motion, and corresponds to the lowering assisting torque calculation block B51 shown in FIG. 17 and the lowering assisting torque calculation unit 61F shown in FIG. 15. As the process SD000L is similar to SD000R, a detailed description thereof will be omitted.

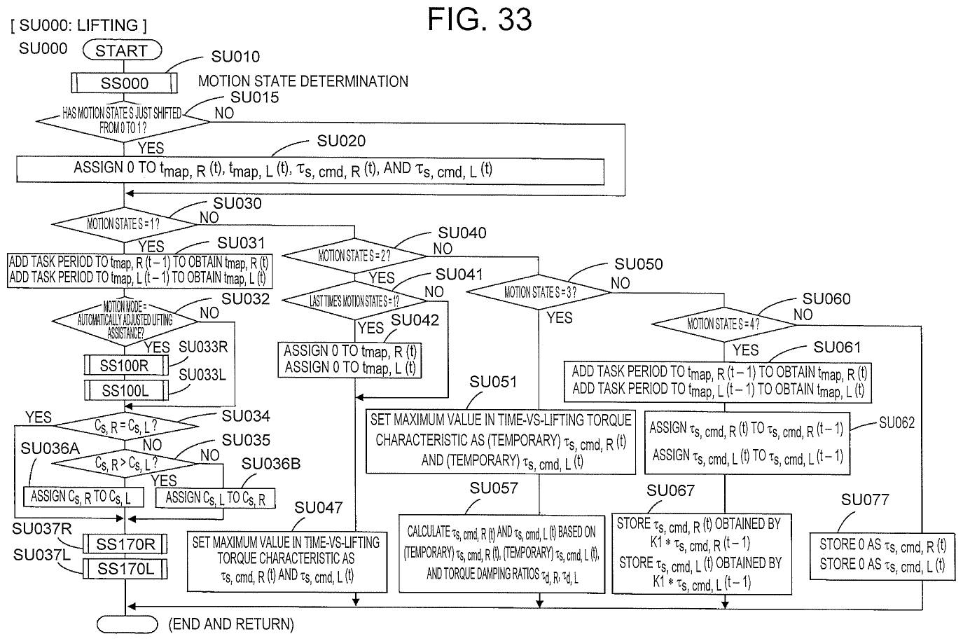

When the controller 61 moves to step S045, the controller 61 executes a process SU000 (see FIG. 33) and moves to step S060R. The process SU000 is a process of obtaining control command values for the (right) actuator unit 4R and the (left) actuator unit 4L during a lifting motion, and corresponds to the lifting assisting torque calculation block B52 shown in FIG. 17 and the lifting assisting torque calculation unit 61G shown in FIG. 15. Details of the process SU000 will be described later.

When the controller 61 moves to step S050, the controller 61 executes a process SW000 (not shown) and moves to step S060R. The process SW000 is a process of obtaining control command values for the (right) actuator unit 4R and the (left) actuator unit 4L during a walking motion, and corresponds to the walking assisting torque calculation block B53 shown in FIG. 17 and the walking assisting torque calculation unit 61H shown in FIG. 15. A detailed description of the process SW000 will be omitted.

In step S060R, the controller 61 performs feedback control on the (right) electric motor based on a (right) assisting torque command value obtained by the process SD000R, SU000, or SW000, and moves to step S060L.

In step S060L, the controller 61 performs feedback control on the (left) electric motor based on a (left) assisting torque command value obtained by the process SD000L, SU000, or SW000, and ends the process. The processes in steps S060R and S060L correspond to the control command value calculation block B60 shown in FIG. 17 and the control command value calculation unit 611 shown in FIG. 15.

Next, the process S100 in step S010 shown in FIG. 18 will be described in detail by using FIG. 19. In the process S100, the controller 61 stores, as the motion mode, one of lowering assistance, lifting assistance with the amount increasing speed automatically adjusted, and lifting assistance with the amount increasing speed manually adjusted, based on the information from the manipulation unit (see “Controller: Motion Mode” in FIG. 16). Except “when motion type=baggage lifting or lowering task and motion state S=1 to 4,” the controller 61 stores one of −1, 0, 1, 2, 3, and 4 as the (right) amount increasing speed C_{s, R} and the (left) amount increasing speed C_{s, L} based on the information from the manipulation unit (see “Controller: Amount Increasing Speed” in FIG. 16). Further, the controller 61 recognizes whether the automatic-manual gain adjustment switching manipulation part is set to “automatic gain adjustment” or “manual gain adjustment” based on the information from the manipulation unit, and stores the result. In the case of “manual gain adjustment,” the controller 61 stores the manual unit gain (one of 0, 1, 2, and 3; see FIG. 16), based on the information from the manipulation unit. This process corresponds to the adjustment determination block B10 shown in FIG. 17 and the adjustment determination unit 61A shown in FIG. 15.

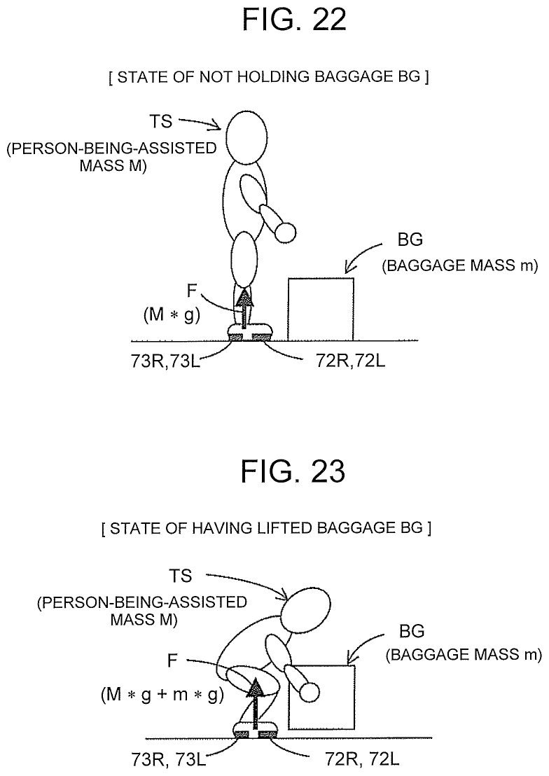

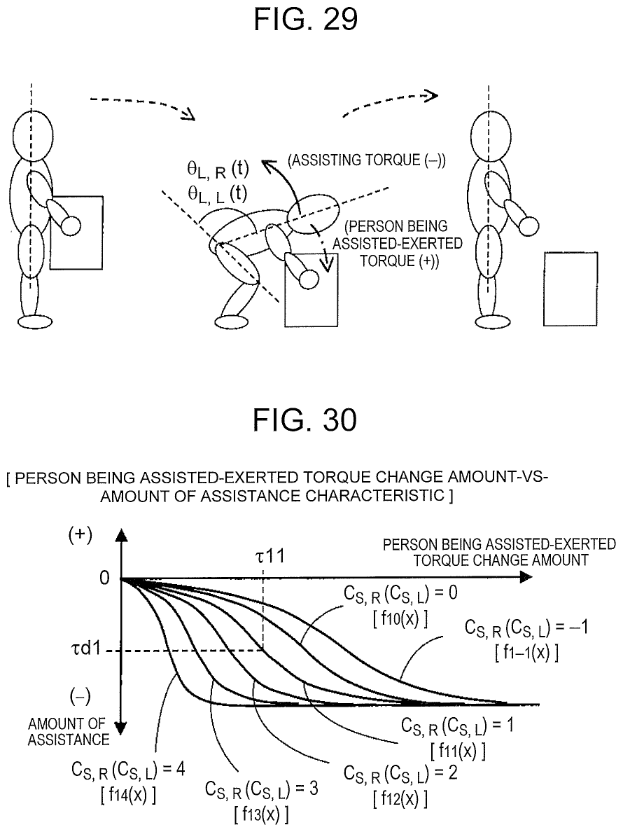

The controller 61 stores an unupdated (right) link angle θ_{L, R} (t) as a last time's (right) link angle θ_{L, R} (t−1), and stores an unupdated (left) link angle θ_{L, L} (t) as a last time's (left) link angle θ_{L, L} (t−1). Further, the controller 61 detects the current (right) link angle by using the output link turning angle detection means 43RS (corresponding to angle detection means; see FIG. 10 and FIG. 11) of the (right) actuator unit, and stores the detected (right) link angle as the (right) link angle θ_{L, R} (t) (updates the (right) link angle θ_{L, R} (t) with the detected (right) link angle). Similarly, the controller 61 detects the current (left) link angle by using the output link turning angle detection means (corresponding to angle detection means) of the (left) actuator unit, and stores the detected (left) link angle as the (left) link angle θ_{L, L} (t) (updates the (left) link angle θ_{L, L} (t) with the detected (left) link angle). Further, based on the information from the manipulation unit, the controller 61 obtains a drag force F (see FIG. 22, FIG. 23, FIG. 25, and FIG. 26) that is based on detection signals from the load detection means 72L, 72R, 73L, 73R. Furthermore, based on a detection signal from the acceleration rate detection means 75, the controller 61 obtains the body motion acceleration rate av (see FIG. 25 and FIG. 26) in the parallel-to-spine direction along the surface of the back of the person being assisted and the body motion acceleration rate aw (see FIG. 25 and FIG. 26) in the orthogonal-to-back direction orthogonal to the surface of the back of the person being assisted, and stores the obtained body motion acceleration rates av, aw. This process corresponds to the input processing block B20 shown in FIG. 17 and the input processing unit 61B shown in FIG. 15. The (right) link angle θ_{L, R} (t) is a (right) forward leaning angle of the hip relative to the thigh (see FIG. 29), and the (left) link angle θ_{L, L} (t) is a (left) forward leaning angle of the hip relative to the thigh (see FIG. 29).

The controller 61 obtains a (right) link angle change amount Δθ_{L, R} (t) by the following Formula 1 and a (left) link angle change amount Δθ_{L, L} (t) by the following Formula 2, and stores the obtained link angle change amounts. Each of the (right) link angle change amount Δθ_{L, R} (t) and the (left) link angle change amount Δθ_{L, L} (t) corresponds to an angular velocity-related amount. The output link turning angle detection means 43RS corresponds to torque detection means.

(Right) link angle change amount Δθ_{L,R}(t)=(right) link angle θ_{L,R}(t)−(right) link angle θ_{L,R}(t−1) (Formula 1)

(Left) link angle change amount Δθ_{L,L}(t)=(left) link angle θ_{L,L}(t)−(left) link angle θ_{L,L}(t−1) (Formula 2)

The controller 61 obtains a (right) person being assisted-exerted torque change amount τ_{S, R} (t) by the following Formula 3 and a (left) person being assisted-exerted torque change amount τ_{S, L} (t) by the following Formula 4, and stores the obtained person being assisted-exerted torque change amounts. The symbol Ks represents the spring constant of the spiral spring 45R.

(Right) person being assisted-exerted torque change amount τ_{D,R}(t)=K_{S}*Δθ_{L,R}(t) (Formula 3)

(Left) person being assisted-exerted torque change amount τ_{S,L}(t)=K_{S}*Δθ_{L,L}(t) (Formula 4)

The controller 61 obtains a (right) combined torque (t) by the following Formula 5 and a (left) combined torque (t) by the following Formula 6, and stores the obtained combined torques. This process corresponds to the torque change amount etc. calculation block B30 shown in FIG. 17 and the torque change amount etc. calculation unit 61C shown in FIG. 15.

(Right) combined torque (t)=K_{S}*Δθ_{L,R}(t) (Formula 5)

(Left) combined torque (t)=K_{S}*Δθ_{L,L}(t) (Formula 6)

Next, the process S200 in step S020 shown in FIG. 18 will be described in detail by using FIG. 20. In the process S200, the controller 61 determines the type of a motion of the person being assisted. The motion types to be determined include “walking” and “baggage lifting or lowering.” Walking is a walking motion of the person being assisted, and baggage lifting or lowering is a motion of the person being assisted lifting a heavy object or putting down a heavy object that the person being assisted is holding. The process S200 corresponds to the motion type determination block B40 shown in FIG. 17 and the motion type determination unit 61D shown in FIG. 15.

In the process S200, the controller 61 moves to step S210. In step S210, the controller 61 determines whether or not [(right) link angle θ_{L, R} (t)+(left) link angle θ_{L, L} (t)]/2 is equal to or smaller than a first motion determining angle θ1 and (right) combined torque (t)*(left) combined torque (t) is smaller than a first motion determining torque τ1. The controller 61 moves to step S230A if [(right) link angle θ_{L, R} (t)+(left) link angle θ_{L, L} (t)]/2 is equal to or smaller than the first motion determining angle θ1 and (right) combined torque (t)*(left) combined torque (t) is smaller than the first motion determining torque τ1 (Yes), and moves to step S220 if not (No).

When the controller 61 moves to step S220, the controller 61 determines whether or not (right) combined torque (t)*(left) combined torque (t) is equal to or larger than a second motion determining torque τ2, and moves to step S230B if (right) combined torque (t)*(left) combined torque (t) is equal to or larger than the second motion determining torque τ2 (Yes), and ends the process S200 and returns (moves to step S025 in FIG. 18) if not (No).

When the controller 61 moves to step S230A, the controller 61 stores “walking” as the motion type, and ends the process S200 and returns (moves to step S025 in FIG. 18).

When the controller 61 moves to step S230B, the controller 61 stores “baggage lifting or lowering task” as the motion type, and ends the process S200 and returns (moves to step S025 in FIG. 18).

Next, the process S300 in step S025 shown in FIG. 18 will be described in detail by using FIG. 21. In the process S300, the controller 61 determines the value of the gain Cₚ that is the amount of assisting torque. For example, in the case where the automatic-manual gain adjustment switching manipulation part RIBS shown in FIG. 14 is set to the “Manual” side, the gain Cₚ is set to one of 0, 1, 2, and 3 by the person being assisted manipulating the gain upward manipulation part R1BU and the gain downward manipulation part R1BD. On the other hand, in the case where the automatic-manual gain adjustment switching manipulation part RIBS shown in FIG. 14 is set to the “Automatic” side, the controller 61 automatically detects the mass (or weight) of baggage that the person being assisted is holding, and according to the detected mass (or weight) of the baggage, determines the value of the gain Cₚ that is the amount of assisting torque. For example, in the controller 61, the gain numbers 0, 1, 2, and 3 of the gain Cₚ for manual adjustment are set so as to correspond to the baggage mass=0 [kg], 10 [kg], 15 [kg], and 20 [kg], respectively. For example, when the mass of the baggage is 18 [kg], the gain Cₚ for manual adjustment is determined as the gain Cₚ=2. However, to further reduce the unpleasant sensation, the assisting torque (the gain Cₚ) may be set to 2.6 according to the baggage mass (e.g., in proportion to the baggage mass). The process S300 corresponds to the load determination block B45 shown in FIG. 17 and the load determination unit 61J shown in FIG. 15.

In the process S300 (see FIG. 21), the controller 61 moves to step S315. Although the drag force F and the body motion acceleration rates av, aw have already been obtained by the process S100 described above, the drag force F and the body motion acceleration rates av, aw will be described first.

As shown in FIG. 22, in a state where a person being assisted TS is not holding baggage BG (baggage mass m), when the person-being-assisted mass is M and the gravitational acceleration rate is g, the drag force F=M*g. The drag force F is a force that the person being assisted TS receives from the floor surface. As shown in FIG. 23, in a state where the person being assisted TS has lifted the baggage BG (baggage mass m), when the person-being-assisted mass is M and the gravitational acceleration rate is g, the drag force F=M*g+m*g. At the point of step S100, the controller 61 temporarily stores this time's drag force F regardless of whether or not the person being assisted TS is holding the baggage BG.

As shown in FIG. 25 and FIG. 26, the acceleration rate detection means 75 outputs a detection signal of the body motion acceleration rate av in the parallel-to-spine direction along the surface of the back of the person being assisted TS, and a detection signal of the body motion acceleration rate aw in the orthogonal-to-back direction orthogonal to the surface of the back of the person being assisted TS. At the point of step S100, the controller 61 detects this time's body motion acceleration rate av in the parallel-to-spine direction based on the detection signal of the body motion acceleration rate av, and this time's body motion acceleration rate aw in the orthogonal-to-back direction based on the detection signal of the body motion acceleration rate aw, and stores the detected body motion acceleration rates av, aw.

In step S315, the controller 61 determines whether or not the automatic-manual gain adjustment switching manipulation part RIBS (see FIG. 14) is set to the “Automatic” side, and moves to step S320 if the automatic-manual gain adjustment switching manipulation part RIBS is set to the “Automatic” side (Yes) and moves to step S360C if the automatic-manual gain adjustment switching manipulation part RIBS is set to the “Manual” side (No).

When the controller 61 moves to step S320, the controller 61 determines whether or not the time that has elapsed since power-on is shorter than a predetermined time (e.g., shorter than about 0.2 to 2 [sec]), and moves to step S330 if the elapsed time is shorter than the predetermined time (Yes) and moves to step S325 if the elapsed time is equal to or longer than the predetermined time (No).

When the controller 61 moves to step S330, the controller 61 determines whether or not |this time's body motion acceleration rate av| is equal to or lower than a predetermined threshold value and |this time's body motion acceleration rate aw| is equal to or lower than a predetermined threshold value (i.e., the person being assisted TS is in a substantially stationary state), and moves to step S340B if |this time's body motion acceleration rates av, aw| are equal to or lower than the predetermined threshold values (Yes), and moves to step S350 if |this time's body motion acceleration rates av, aw| are higher than the predetermined threshold values (No).

When the controller 61 moves to step S340B, the controller 61 integrates this time's drag force F and adds one to the number of times of integration, and moves to step S350.

When the controller 61 moves to step S325, the controller 61 determines whether or not the time that has elapsed since power-on is equal to the predetermined time (that has the same value as the “predetermined time” in step S320), and moves to step S340A if the elapsed time is equal to the predetermined time (Yes) and moves to step S350 if the elapsed time is not equal to the predetermined time (No).

When the controller 61 moves to step S340A, the controller 61 averages the integrated value (the integrated value of the drag force F) obtained in step S340B by the number of times of integration, to thereby obtain an average person-being-assisted drag force Fav that is a drag force due to only the person being assisted TS. Then, the controller 61 divides the average person-being-assisted drag force Fav by the gravitational acceleration rate g to obtain the person-being-assisted mass M (M=Fav/g), stores the obtained person-being-assisted mass M, and moves to step S350. It is preferable that the person-being-assisted mass M be stored in a non-volatile memory.

Alternatively, the controller 61 may use the drag force F that has been detected while the body weight measurement manipulation part R1K (see FIG. 14) is on, to obtain the person-being-assisted mass M by dividing the drag force F at that time by the gravitational acceleration rate g (M=F/g), and then store the obtained person-being-assisted mass M. In this case, the person being assisted TS turns on the body weight measurement manipulation part R1K without holding the baggage BG.

When the controller 61 moves to step S350, the controller 61 determines whether or not this time's drag force F is larger than the person-being-assisted mass M*g +a predetermined load (e.g., 2 to 3 [kg]*g, where g is the gravitational acceleration rate), and moves to step S355 if this time's drag force F is larger (Yes), and moves to step S360B if not (No).

When the controller 61 moves to step S355, the controller 61 calculates the baggage mass m, for example, by the following Calculation Method 1 of Baggage Mass m or Calculation Method 2 of Baggage Mass m, and moves to step S360A.

### Calculation Method 1 of Baggage Mass m

As shown in FIG. 23, the controller 61 assumes that this time's drag force F is a drag force due to the person-being-assisted mass M and the baggage mass m, and calculates the baggage mass m by this time's drag force F (M*g+m*g)/g−(person-being-assisted mass M). In the case where this Calculation Method 1 of Baggage Mass m is used, the acceleration rate detection means 75 can be omitted.

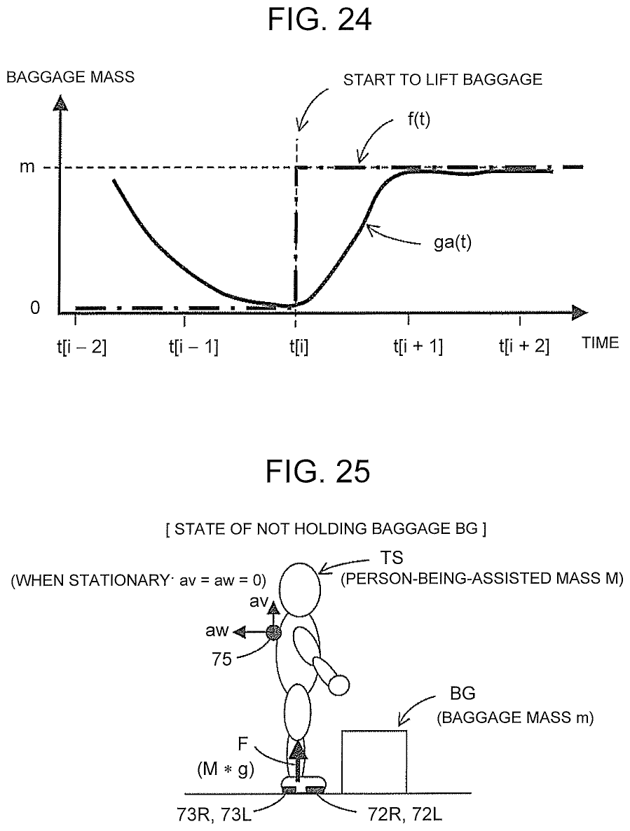

With time plotted on the abscissa and the mass of baggage that the person being assisted is holding plotted on the ordinate, FIG. 24 shows an example of the baggage mass m that was actually calculated by Calculation Method 1 when the person being assisted TS started to lift the baggage BG at time t [i]. The long dashed-short dashed line f (t) shown in FIG. 24 represents an ideal baggage mass, which is zero before time t [i] as the person being assisted TS is not holding the baggage BG, and which is m after time t [i] as the person being assisted TS has lifted the baggage BG. However, the baggage mass calculated by Calculation Method 1 is the solid line ga (t) shown in FIG. 24. According to this calculation, a gradually decreasing baggage mass is erroneously detected before time t [i] due to factors such as an acceleration rate of the person being assisted TS as the person stoops toward the baggage BG, and a gradually increasing baggage mass is detected after time t [i] due to factors such as a delay in response of the load detection means. However, this is not a major problem, as the baggage mass converges to the correct baggage mass m by time t [i+1] after time t [i]. Moreover, the response delay time is short and therefore the person being assisted feels hardly any unpleasant sensation. While determining that the person being assisted is holding baggage despite the person not holding baggage before time t [i], is not a major problem but not very favorable. (The motion of the person being assisted relative to the baggage can be known by estimating the bending angle of the hips by the output link turning angle detection means 43RS and the motor rotation angle detection means 47RS.) Thus determining that the person being assisted is holding baggage before time t [i] is avoided by Calculation Method 2.

### Calculation Method 2 of Baggage Mass m

As shown in FIG. 26, the controller 61 obtains the baggage mass m based on the assumption that this time's drag force F is a drag force due to the person-being-assisted mass M, the baggage mass m, and the body motion acceleration rate az of a vertical direction component of the person being assisted TS. Based on the body motion acceleration rates av, aw, etc., the controller 61 obtains the body motion acceleration rate az of the vertical direction component. For example, the controller 61 obtains the body motion acceleration rate az from az=√(av²+aw²). In this case, the drag force F=(M+m)*(g+az). Therefore, F=M*g+M*az+m*g+m*az. Here, since m is smaller than M and az is lower than g (gravitational acceleration rate), m*az is regarded as zero. Then, F=M*g+M*az+m*g. From this formula, m=[F−M*(g+az)]/g, and the controller 61 obtains the baggage mass m from this formula.

With time plotted on the abscissa and the mass of baggage that a person being assisted is holding plotted on the ordinate, FIG. 27 shows an example of the baggage mass m that was actually calculated by Calculation Method 2 when the person being assisted TS started to lift the baggage BG at time t [i]. The long dashed-short dashed line f (t) shown in FIG. 27 represents an ideal baggage mass, which is zero before time t [i] as the person being assisted TS is not holding the baggage BG and which is m after time t [i] as the person being assisted TS has lifted the baggage BG The baggage mass calculated by Calculation Method 2 is the solid line gb (t) shown in FIG. 27. Compared with FIG. 24, erroneous detection before time t [i] due to factors such as an acceleration rate of the person being assisted TS as the person stoops toward the baggage BG is avoided. On the other hand, as in FIG. 24, a gradually increasing baggage mass is detected after time t [i] due to factors such as a delay in response of the load detection means. However, this is not a major problem, as the baggage mass converges to the correct baggage mass m by time t [i+1] after time t [i]. Moreover, determining that the person being assisted is holding baggage before time t [i] is avoided, and therefore there is no problem.

When the controller 61 moves to step S360A, the controller 61 converts the obtained baggage mass m into the value of the gain Cₚ, and ends the process S300 and returns (moves to step S030 in FIG. 18). As an example of the conversion, in the case where the gain numbers 0, 1, 2, and 3 shown in FIG. 16 correspond to the baggage mass=0 [kg], 10 [kg], 15 [kg], and 20 [kg], respectively, when the baggage mass m=18 [kg], for example, the controller 61 converts the baggage mass 18 [kg] into the gain Cₚ=2.6.

When the controller 61 moves to step S360B, since the controller 61 has determined that the person being assisted TS is not holding the baggage BG (baggage mass m=0), the controller 61 sets the gain Cₚ=0, and ends the process S300 and returns (moves to step S030 in FIG. 18).

When the controller 61 moves to step S360C, the controller 61 uses the gain number in “Manipulation Unit: Gain” shown in FIG. 16 (that has been obtained by the process S100 described above), and assigns the applicable gain number (one of 0, 1, 2, and 3) into the gain Cₚ, and ends the process S300 and returns (moves to step S030 in FIG. 18).

Next, the process SD000R in step S040R shown in FIG. 18 will be described in detail by using FIG. 28. In the process SD000R, the controller 61 calculates a (right) lowering assisting torque to be generated by the assist device to assist the person being assisted in performing a lowering task. For the process SD000R, the procedure of the process of calculating the (right) lowering assisting torque to be generated by the (right) actuator unit 4R (see FIG. 1) is shown. The procedure of the process SD000L (see FIG. 18) of calculating a (left) lowering assisting torque to be generated by the (left) actuator unit 4L (see FIG. 1) is similar and therefore the description thereof will be omitted. As shown in FIG. 29, in a lowering task in which the person being assisted puts down baggage that the person being assisted is holding, the (right) link angle θ_{L, R} (t) and the (left) link angle θ_{L, L} (t) are forward leaning angles of the hips relative to the thighs. The lowering assisting torque that assists the person being assisted in performing a task in a lowering direction (the direction of “person being assisted-exerted torque” in FIG. 29) is generated in a lifting direction relative to the person being assisted (the direction of “assisting torque” in FIG. 29). In the following description, the sign of a torque in the lifting direction and the sign of a torque in the lowering direction will be written as “−” (negative) and “+” (positive), respectively.

In the process SD000R, the controller 61 moves to step SD010R. In step SD010R, the controller 61 determines whether or not the (right) link angle θ_{L, R} (t) is equal to or smaller than a first lowering angle θd1, and moves to step SD015R if the (right) link angle θ_{L, R} (t) is equal to or smaller than the first lowering angle θd1 (Yes) and moves to step SD020R if not (No). For example, the first lowering angle θd1 is a forward leaning angle of about 10[°], and when θ_{L, R} (t) θd1, the controller 61 determines that lowering has started or ended.

When the controller 61 moves to step SD015R, the controller 61 initializes (resets to zero) a (right) integrated amount of assistance and moves to step SD020R.

When the controller 61 moves to step SD020R, the controller 61 calculates a (right) amount of assistance based on the (right) amount increasing speed C_{s, R}, the (right) person being assisted-exerted torque change amount τ_{S, R} (t), and a person being assisted-exerted torque change amount-vs-amount of assistance characteristic (FIG. 30), and moves to step SD025R. As shown in FIG. 30, for example, when the (right) amount increasing speed C_{s, R}=1 and the (right) person being assisted-exerted torque change amount τ_{S, R} (t)=τ11, the controller 61 uses the characteristic f11 (x) of C_{s, R}=1 and thereby obtains τd1 corresponding to τ11 as the (right) amount of assistance.

In step SD025R, the controller 61 adds the (right) amount of assistance obtained in step SD020R to the (right) integrated amount of assistance (i.e., integrates the obtained (right) amount of assistance), and moves to step SD030R.

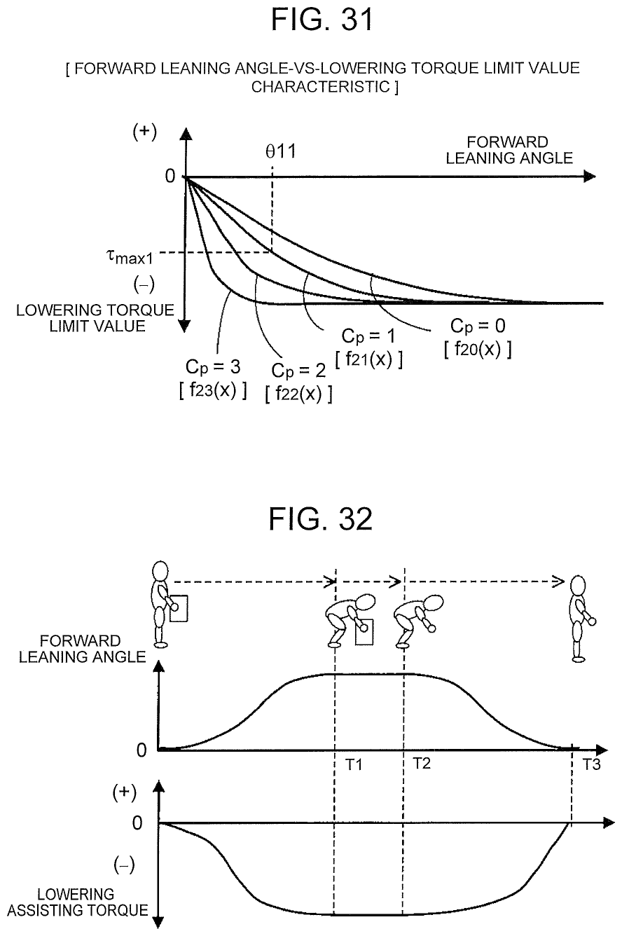

In step SD030R, the controller 61 calculates a (right) lowering torque limit value based on the gain Cₚ, the (right) link angle (forward leaning angle) θ_{L, R} (t), and a forward leaning angle-vs-lowering torque limit value characteristic (see FIG. 31), and moves to step SD035R. As shown in FIG. 31, for example, when the gain Cₚ=1 and the (right) link angle (forward leaning angle) θ_{L, R} (t)=θ11, the controller 61 uses the characteristic f21 (x) of Cₚ=1 and thereby obtains τmax1 corresponding to θ11 as the (right) lowering torque limit value. For example, in the case where the gain Cₚ=2.6, a value in the characteristic of the Cₚ=2 and a value in the characteristic of the Cₚ=3 may be obtained, and a value corresponding to Cₚ=2.6 may be obtained from these two values by interpolation. The forward leaning angle-vs-lowering torque limit value characteristic shown in FIG. 31 is one of a plurality of maps in which the assisting torque-related amount is preset.

In step SD035R, the controller 61 determines whether or not |(right) integrated amount of assistance| is equal to or smaller than |(right) lowering torque limit value|, and moves to step SD040R if |(right) integrated amount of assistance| is equal to or smaller than |(right) lowering torque limit value| (Yes) and moves to step SD045R if not (No).

When the controller 61 moves to step SD040R, the controller 61 stores the (right) integrated amount of assistance as the (right) lowering assisting torque (i.e., a (right) assisting torque command value τ_{s, cmd, R} (t)), and ends the process and returns (moves to step S060R in FIG. 18).

When the controller 61 moves to step SD045R, the controller 61 stores the (right) lowering torque limit value as the (right) lowering assisting torque (i.e., the (right) assisting torque command value τ_{s, cmd, R} (t)), and ends the process and returns (moves to step S060R in FIG. 18).

By steps SD035R, SD040R, and SD045R, the controller 61 sets |(right) integrated amount of assistance| or |(right) lowering torque limit value|, whichever is the smaller, as the (right) lowering assisting torque.

FIG. 32 shows how the lowering assisting torque is set so as to correspond to the forward leaning angle during a lowering task by the above process. The example shown in FIG. 32 shows a case where the person being assisted holds baggage in an upright standing state at time 0, completes lowering of the baggage at time T1 while gradually increasing the forward leaning angle, maintains a forward leaning state until time T2, and returns to the upright standing state while gradually reducing the forward leaning angle. In this case, the lowering assisting torque in the lifting direction (toward the − (negative) side in FIG. 32) is as shown in FIG. 32, and thus the assist device can appropriately provide assistance in the lowering task by reducing the burden on the hips of the person being assisted.

When the person being assisted stops a forward leaning motion and the forward leaning angle stops changing (Δθ_{L, R} (t)=0, Δθ_{L, L} (t)=0) (in the example of FIG. 32, from time T1 to time T2), or when the person being assisted is performing an upright standing motion in which the person being assisted gradually reduces the forward leaning angle from the forward leaning state (in the example of FIG. 32, from time T2 to time T3), the person being assisted-exerted torque change amount is zero or directed in the opposite direction, so that the amount of assistance obtained from the person being assisted-exerted torque change amount-vs-amount of assistance characteristic (see FIG. 30) becomes zero. In this case, the controller 61 stops updating and retains the integrated amount of assistance, and obtains the (right) lowering assisting torque ((right) assisting torque command value) based on the retained integrated amount of assistance and the lowering torque limit value.

Next, the process SU000 in step S045 shown in FIG. 18 will be described in detail by using FIG. 33. In the process SU000, the controller 61 calculates a lifting assisting torque to be generated by the assist device to assist the person being assisted in performing a lifting task. In the lifting task in which the person being assisted lifts baggage, the (right) link angle θ_{L, R} (t) and the (left) link angle θ_{L, L} (t) (see FIG. 29) are forward leaning angles of the hips relative to the thighs. The lifting assisting torque that assists the person being assisted in performing a task in the lifting direction is generated in the lifting direction relative to the person being assisted (the direction of “assisting torque” in FIG. 29). In the following description, the sign of a torque in the lifting direction and the sign of a torque in the lowering direction will be written as “−” (negative) and “+” (positive), respectively.

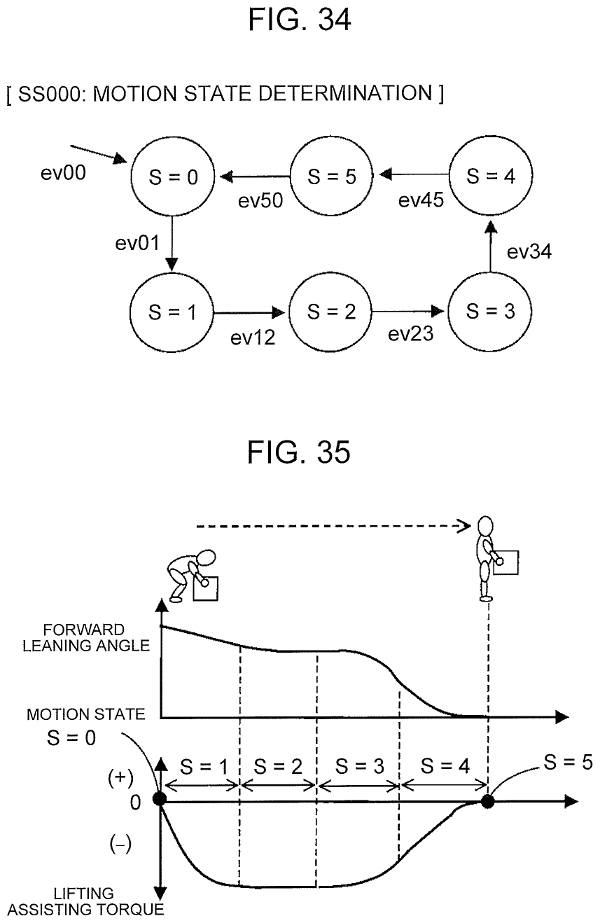

In the process SU000, the controller 61 moves to step SU010. In step SU010, the controller 61 executes the process SS000 (see FIG. 34) and moves to step SU015. As shown in the state shift chart of FIG. 34, the process SS000 is a process of determining the current motion state S, with the entire lifting motion from the start to the end of lifting divided into six motion states S of 0 to 5. Details of this process will be described later.

In step SU015, the controller 61 determines whether or not the motion state S has just shifted from 0 to 1, and moves to step SU020 if the motion state S has just shifted from 0 to 1 (Yes) and moves to step SU030 if not (No).

When the controller 61 moves to step SU020, the controller 61 assigns 0 to a (right) virtual elapsed time t_{map, R} (t) and a (left) virtual elapsed time t_{map, L} (t), and assigns 0 to the (right) lifting assisting torque ((right) assisting torque command value τ_{s, cmd, R} (t)) and the (left) lifting assisting torque ((left) assisting torque command value τ_{s, cmd, L} (t)). Then, the controller 61 moves to step SU030.

When the controller 61 moves to step SU030, the controller 61 determines whether or not the motion state S determined in step SU020 is 1, and moves to step SU031 if the motion state S is 1 (Yes) and moves to step SU040 if not (No).

When the controller 61 moves to step SU031, the controller 61 adds a task period (e.g., 2 [ms] in the case where the process shown in FIG. 18 is started every 2 [ms]) to the (right) virtual elapsed time t_{map, R} (t), and adds the task period to the (left) virtual elapsed time t_{map, L} (t), and moves to step SU032. Each of the (right) virtual elapsed time t_{map, R} (t) and the (left) virtual elapsed time t_{map, L} (t) represents a (virtual) time that has elapsed since the motion state S became 1.

In step SU032, the controller 61 determines whether or not the motion mode is “lifting assistance with the amount increasing speed automatically adjusted,” and moves to step SU033R if the motion mode is “lifting assistance with the amount increasing speed automatically adjusted” (Yes) and moves to step SU034 if not (No).

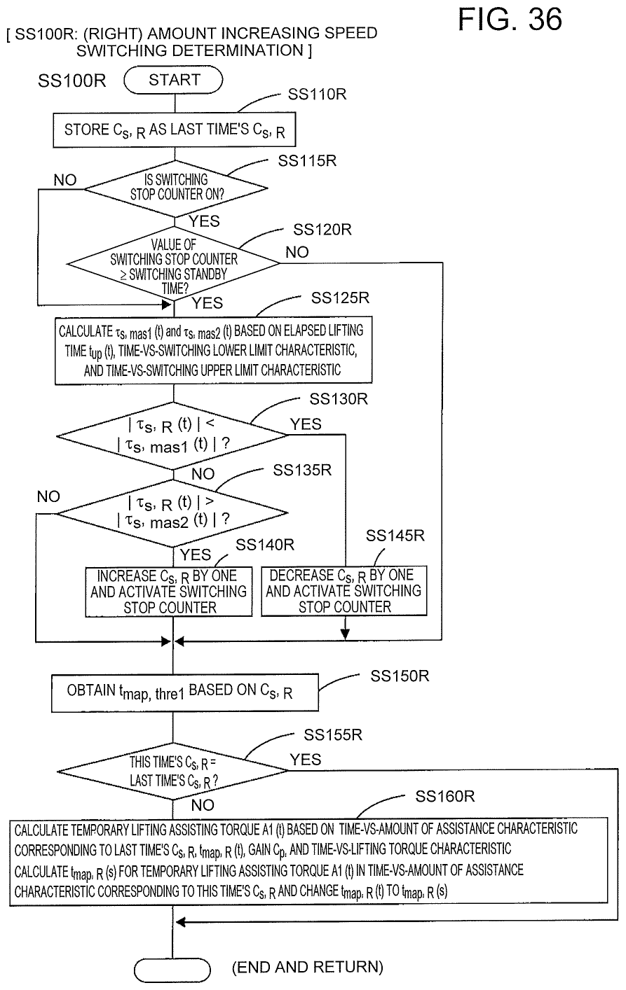

When the controller 61 moves to step SU033R, the controller 61 executes a process SS100R (see FIG. 36) and moves to step SU033L. The process SS100R (see FIG. 36) is a process of changing or maintaining the (right) amount increasing speed C_{s, R} and the (right) virtual elapsed time t_{map, R} (t). A process SS100L is a similar process of changing or maintaining the (left) amount increasing speed C_{s, L} and the (left) virtual elapsed time t_{map, L} (t), and therefore the description thereof will be omitted. In step SU033L, the controller 61 executes the process SS100L and moves to step SU034. Details of the process SS100R will be described later.

In step SU034, the controller 61 determines whether or not the (right) amount increasing speed C_{s, R} and the (left) amount increasing speed C_{s, L} are equal, and moves to step SU037R if the (right) amount increasing speed C_{s, R} and the (left) amount increasing speed C_{s, L} are equal (Yes) and moves to step SU035 if not (No).

When the controller 61 moves to step SU035, the controller 61 determines whether or not the (right) amount increasing speed C_{s, R} is higher than the (left) amount increasing speed C_{s, L}, and moves to step SU036A if the (right) amount increasing speed C_{s, R} is higher than the (left) amount increasing speed C_{s, L} (Yes) and moves to step SU036B if not (No).

When the controller 61 moves to step SU036A, the controller 61 assigns the (right) amount increasing speed C_{s, R} to the (left) amount increasing speed C_{s, L} and moves to step SU037R.

When the controller 61 moves to step SU036B, the controller 61 assigns the (left) amount increasing speed C_{s, L} to the (right) amount increasing speed C_{s, R} and moves to step SU037R.

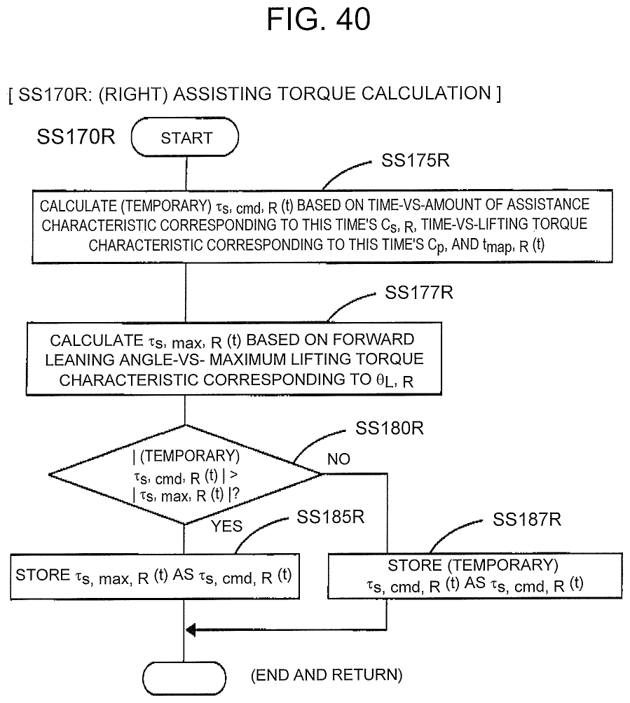

When the controller 61 moves to step SU037R, the controller 61 executes a process SS170R (see FIG. 40) and moves to step SU037L. The process SS170R (see FIG. 40) is a process of obtaining the (right) lifting assisting torque ((right) assisting torque command value τ_{s, cmd, R} (t)) in the case where the motion state S=1. A process SS170L is a similar process of obtaining the (left) lifting assisting torque ((left) assisting torque command value τ_{s, cmd, L} (t)) in the case where the motion state S=1, and therefore the description thereof will be omitted. In step SU037L, the controller 61 executes the process SS170L, and ends the process and returns (moves to step S060R in FIG. 18). Details of the process SS170R will be described later.

When the controller 61 moves to step SU040, the controller 61 determines whether or not the motion state S determined in step SU020 is 2, and moves to step SU041 if the motion state S is 2 (Yes) and moves to step SU050 if not (No).

When the controller 61 moves to step SU041, the controller 61 determines whether or not the (last time's) motion state S is 1, and moves to step SU042 if the (last time's) motion state S is 1 (Yes) and moves to step SU047 if not (No).

When the controller 61 moves to step SU042, the controller 61 assigns 0 to the (right) virtual elapsed time t_{map, R} (t) and the (left) virtual elapsed time t_{map, L} (t) and moves to step SU047. The process in step SU042 is a process executed when the motion state S has shifted from 1 to 2.

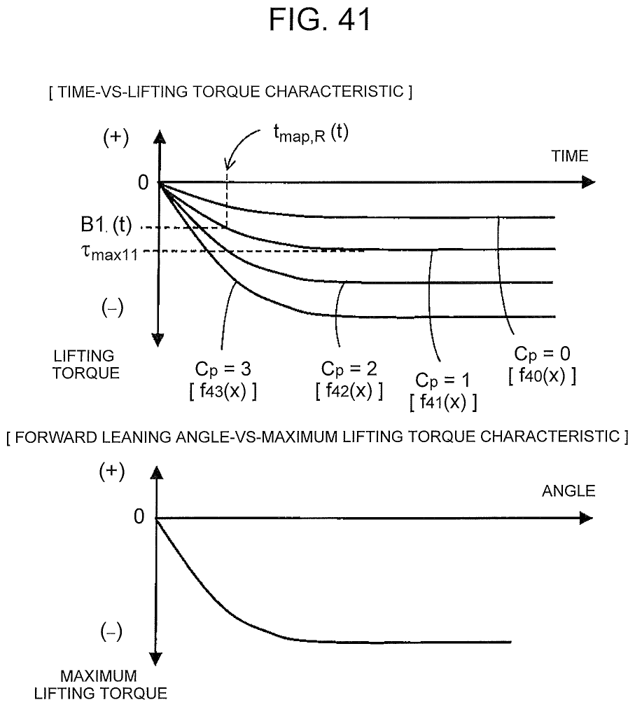

When the controller 61 moves to step SU047, the controller 61 obtains a |maximum value| corresponding to the gain Cₚ based on the gain Cₚ and a time-vs-lifting torque characteristic (see FIG. 41), and assigns the obtained maximum value to the (right) lifting assisting torque ((right) assisting torque command value τ_{s, cmd, R} (t)) and the (left) lifting assisting torque ((left) assisting torque command value τ_{s, cmd, L} (t)), and ends the process and returns (moves to step S060R in FIG. 18). For example, in the case where the gain Cₚ=1, the controller 61 uses the characteristic f41 (x) of Cₚ=1 in FIG. 41 and thereby obtains τmax11 that is the maximum value of |f41 (x)|, as the maximum value. As shown in FIG. 41, the time-vs-lifting torque characteristic (one of reference lifting characteristics) is prepared according to the gain Cₚ, and the controller 61 changes the reference lifting characteristic according to the gain Cₚ. For example, in the case where the gain Cₚ=2.6, a value in the characteristic of the gain Cₚ=2 and a value in the characteristic of the gain Cₚ=3 may be obtained, and a value corresponding to Cₚ=2.6 may be obtained from these two values by interpolation. The time-vs-lifting torque characteristic shown in FIG. 41 is one of the maps in which the assisting torque-related amount is preset.

When the controller 61 moves to step SU050, the controller 61 determines whether or not the motion state S determined in step SU020 is 3, and moves to step SU051 if the motion state S is 3 (Yes) and moves to step SU060 if not (No).

When the controller 61 moves to step SU051, the controller 61 obtains a maximum value corresponding to the gain Cₚ based on the gain Cₚ and the time-vs-lifting torque characteristic (see FIG. 41), and assigns the obtained maximum value to a (temporary) (right) lifting assisting torque ((temporary) τ_{s, cmd, R} (t)) and a (temporary) (left) lifting assisting torque ((temporary) τ_{s, cmd, L} (t)), and moves to step SU057. For example, in the case where the gain Cₚ=1, the controller 61 uses the characteristic f41 (x) of Cₚ=1 in FIG. 41 and thereby obtains τmax11 that is the maximum value of |f41 (x)|, as the maximum value. For example, in the case where the gain Cₚ=2.6, a value in the characteristic of the gain Cₚ=2 and a value in the characteristic of the gain Cₚ=3 may be obtained, and a value corresponding to Cₚ=2.6 may be obtained from these two values by interpolation.

In step SU057, the controller 61 obtains a (right) torque damping ratio τ_{d, R} based on the gain Cₚ, the (right) person being assisted-exerted torque change amount τ_{S, R} (t), and an assistance ratio-vs-torque damping ratio characteristic (see FIG. 43). Similarly, the controller 61 obtains a (left) torque damping ratio τ_{d, L} based on the gain Cₚ, the (left) person being assisted-exerted torque change amount τ_{S, L} (t), and the assistance ratio-vs-torque damping ratio characteristic (see FIG. 43). The controller 61 obtains the (right) assisting torque command value τ_{s, cmd, R} (t) by the following Formula 7 and the (left) assisting torque command value τ_{s, cmd, L} (t) by the following Formula 8, and stores the obtained values. Then, the controller 61 ends the process and returns (moves to step S060R in FIG. 18).

(Right) assisting torque command value τ_{s,cmd,R}(t)=(temporary)τ_{s,cmd,R}(t)*(right) torque damping ratio τ_{d,R} (Formula 7)

(Left) assisting torque command value τ_{s,cmd,L}(t)=(temporary)τ_{s,cmd,L}(t)*(left) torque damping ratio τ_{d,L} (Formula 8)

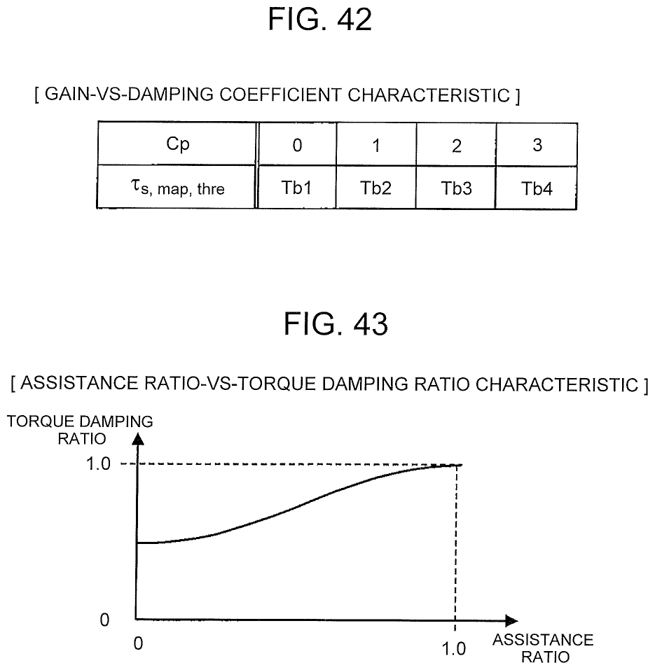

For example, in the case where the gain Cₚ=1, the controller 61 obtains a damping coefficient τ_{s, map, thre}=Tb2 based on the gain-vs-damping coefficient characteristic shown in FIG. 42. Then, the controller 61 calculates a (right) assistance ratio by the following Formula 9 and calculates a (left) assistance ratio by the following Formula 10. For example, in the case where the gain Cₚ=2.6, Tb3 corresponding to the gain Cₚ=2 and Tb4 corresponding to the gain Cₚ=3 may be obtained, and a value corresponding to Cₚ=2.6 may be obtained from these two values (Tb3, Tb4) by interpolation. The gain-vs-damping coefficient characteristic shown in FIG. 42 is one of the maps (data tables) in which the assisting torque-related amount is preset.

(Right) assistance ratio=[τ_{s,map,thre}−(right) person being assisted-exerted torque change amount τ_{S,R}(t)]/τ_{s,map,thre} (Formula 9)

(Left) assistance ratio=[τ_{s,map,thre}−(left) person being assisted-exerted torque change amount τ_{S,L}(t)]/τ_{s,map,thre} (Formula 10)

The controller 61 obtains the (right) torque damping ratio τ_{d, R} based on the (right) assistance ratio and the assistance ratio-vs-torque damping ratio characteristic (see FIG. 43), and obtains the (left) torque damping ratio τ_{d, L} based on the (left) assistance ratio and the assistance ratio-vs-torque damping ratio characteristic (see FIG. 43). Then, the controller 61 stores the result of (temporary) τ_{s, cmd, R} (t)*(right) torque damping ratio τ_{d, R} as the (right) lifting assisting torque ((right) assisting torque command value τ_{s, cmd, R} (t)), and stores the result of (temporary) τ_{s, cmd, L} (t)*(left) torque damping ratio τ_{d, L} as the (left) lifting assisting torque ((left) assisting torque command value τ_{s, cmd, L} (t)).

When the controller 61 moves to step SU060, the controller 61 determines whether or not the motion state S determined in step SU020 is 4, and moves to step SU061 if the motion state S is 4 (Yes) and moves to step SU077 if not (No).

When the controller 61 moves to step SU061, the controller 61 adds a task period (e.g., 2 [ms] in the case where the process shown in FIG. 18 is started every 2 [ms]) to the (right) virtual elapsed time t_{map, R} (t), and adds the task period to the (left) virtual elapsed time t_{map, L} (t), and moves to step SU062. Each of the (right) virtual elapsed time t_{map, R} (t) and the (left) virtual elapsed time t_{map, L} (t) represents a (virtual) time that has elapsed since the motion state S became 4.

In step SU062, the controller 61 assigns the current τ_{s, cmd, R} (t) to the (last time's) τ_{s, cmd, R} (t−1) and assigns the current τ_{s, cmd, L} (t) to the (last time's) τ_{s, cmd, L} (t−1), and moves to step SU067.

In step SU067, the controller 61 obtains the (right) assisting torque command value τ_{s, cmd, R} (t) by the following Formula 11 and the (left) assisting torque command value τ_{s, cmd, L} (t) by the following Formula 12, and stores the obtained values. A damping coefficient K1 is a preset coefficient, which is set to 0.9, for example. Then, the controller 61 ends the process and returns (moves to step S060R in FIG. 18).

(Right) assisting torque command value τ_{s,cmd,R}(t)=K1*(last time's) τ_{s,cmd,R}(t−1) (Formula 11)

(Left) assisting torque command value τ_{s,cmd,L}(t)=K1*(last time's) τ_{s,cmd,L}(t−1) (Formula 12)

When the controller 61 moves to step SU077, the controller 61 obtains the (right) assisting torque command value τ_{s, cmd, R} (t) by the following Formula 13 and the (left) assisting torque command value τ_{s, cmd, L} (t) by the following Formula 14, and stores the obtained values. Then, the controller 61 ends the process and returns (moves to step S060R in FIG. 18).

(Right) assisting torque command value τ_{s,cmd,R}(t)=0 (Formula 13)

(Left) assisting torque command value τ_{s,cmd,L}(t)=0 (Formula 14)

As has been described above, during a lifting task, the controller 61 shifts the motion state S sequentially from 0 to 5 according to the lifting state, and obtains the (right) lifting assisting torque ((right) assisting torque command value τ_{s, cmd, R} (t)) and the (left) lifting assisting torque ((left) assisting torque command value τ_{s, cmd, L} (t)) in accordance with the preset calculation methods corresponding to the respective motion states S.

Next, the process SS000 in step SU010 shown in FIG. 33 will be described in detail by using FIG. 34. In the process SS000, the controller 61 determines the motion state S=0 to 5 according to the lifting state during a lifting task of the person being assisted. An overview of the motion state S is as shown in FIG. 35: 0 represents a motion state S at a point in time when the person being assisted starts to lean forward from the upright standing state (the state in which the person being assisted has stopped leaning forward in the preceding task) and starts a lifting motion; 1 represents a motion state S to which the motion state shifts after the lifting motion has started; 2 represents a motion state S where the person being assisted is performing a baggage lifting motion; 3 and 4 represent motion states S where the person being assisted gradually reduces the forward leaning angle; and 5 represents a motion state S where the person being assisted has completed lifting of the baggage and assumed the upright standing state. The motion state S is set according to the lifting state including at least one of the (right) virtual elapsed time t_{map, R} (t), the (left) virtual elapsed time t_{map, L} (t), the (right) link angle (forward leaning angle) θ_{L, R} (t), the (left) link angle (forward leaning angle) θ_{L, L} (t), the (right) person being assisted-exerted torque change amount τ_{S, R} (t), and the (left) person being assisted-exerted torque change amount τ_{S, L} (t).

In the following, the procedure of determining the motion state S will be described by using the state shift chart shown in FIG. 34. As shown in FIG. 34, the controller 61 determines that the motion state S is 0 by an event ev00 that lifting has started. Whether or not lifting has started can be determined based on the (right) link angle θ_{L, R} (t), the (left) link angle θ_{L, L} (t), the (right) link angle change amount Δθ_{L, R} (t), the (left) link angle change amount Δθ_{L, L} (t), the (right) person being assisted-exerted torque change amount τ_{S, R} (t), the (left) person being assisted-exerted torque change amount τ_{S, L} (t), etc. In the case where the motion state S=0, the controller 61 shifts the motion state S from 0 to 1 upon detecting an event ev01. The event ev01 is “always,” and therefore, as shown in step SU015 in FIG. 33, the controller 61 unconditionally shifts the motion state S to 1 after shifting the motion state S to 0.

In the case where the motion state S=1, the controller 61 shifts the motion state S from 1 to 2 upon detecting an event ev12. When the event ev12 is not detected, the controller 61 maintains the motion state S=1. For example, the event ev12 is detected as having occurred when the condition “(right) virtual elapsed time t_{map, R} (right) t_{map, thre1}” is met or the condition “(left) virtual elapsed time t_{map, L} (t)≥(left) t_{map, thre1}” is met, or when either the (right) link angle (forward leaning angle) θ_{L, R} (t) or the (left) link angle (forward leaning angle) θ_{L, L} (t) becomes a forward leaning angle equivalent to that of near the end of the lifting task. The (right) t_{map, thre1} is determined based on the (right) amount increasing speed C_{s, R} and an amount increasing speed-vs-shift time characteristic (see FIG. 38), and the (left) t_{map, thre1} is determined based on the (left) amount increasing speed C_{s, L} and the amount increasing speed-vs-shift time characteristic (see FIG. 38).

In the case where the motion state S=2, the controller 61 shifts the motion state S from 2 to 3 upon detecting an event ev23. When the event ev23 is not detected, the controller 61 maintains the motion state S=2. For example, the event ev23 is detected as having occurred when the (right) person being assisted-exerted torque change amount τ_{S, R} (t) or the (left) person being assisted-exerted torque change amount τ_{S, L} (t) becomes a relatively small amount equivalent to that of near the end of the lifting task, or when the (right) link angle (forward leaning angle) θ_{L, R} (t) or the (left) link angle (forward leaning angle) θ_{L, L} (t) becomes a forward leaning angle equivalent to that of near the end of the lifting task.

In the case where the motion state S=3, the controller 61 shifts the motion state S from 3 to 4 upon detecting an event ev34. When the event ev34 is not detected, the controller 61 maintains the motion state S=3. For example, the event ev34 is detected as having occurred when the condition “(right) person being assisted-exerted torque change amount τ_{S, R} (t)≥τ_{s, map, thre}” is met or the condition “(left) person being assisted-exerted torque change amount τ_{S, L} (t)≥τ_{s, map, thre}” is met, or when the (right) link angle (forward leaning angle) θ_{L, R} (t) or the (left) link angle (forward leaning angle) θ_{L, L} (t) becomes a forward leaning angle equivalent to that of near the end of the lifting task. The damping coefficient τ_{s, map, thre} is determined based on the gain Cₚ and the gain-vs-damping coefficient characteristic (see FIG. 42).

In the case where the motion state S=4, the controller 61 shifts the motion state S from 4 to 5 upon detecting an event ev45. When the event ev45 is not detected, the controller 61 maintains the motion state S=4. For example, the event ev45 is detected as having occurred when the condition “(right) virtual elapsed time t_{map, R} (t)≥state determining time t41 (e.g., about 0.15 [sec])” is met or the condition “(left) virtual elapsed time t_{map, L} (t)≥state determining time t41 (e.g., about 0.15 [sec])” is met.

In the case where the motion state S=5, the controller 61 shifts the motion state S from 5 to 0 upon detecting an event ev50. When the event ev50 is not detected, the controller 61 maintains the motion state S=5. The event ev50 is a start of the lifting task, and the motion state S returns to 0 upon completion of the lifting task.

Next, the process SS100R in step SU033R shown in FIG. 33 will be described in detail by using FIG. 36. In the process SS100R, the controller 61 automatically switches the (right) amount increasing speed C_{s, R} to an appropriate value from −1 to 4 according to the lifting motion of the person being assisted. For the process SS100R, the procedure of the process of automatically switching the (right) amount increasing speed C_{s, R} is shown. The procedure of the process SS100L (see FIG. 33) of automatically switching the (left) amount increasing speed C_{s, L} is similar and therefore the description thereof will be omitted.

In the process SS100R, the controller 61 moves to step SS110R. In step SS110R, the controller 61 stores the current (right) amount increasing speed C_{s, R} as the last time's C_{s, R} and moves to step SS115R.

In step SS115R, the controller 61 determines whether or not a switching stop counter is on, and moves to step SS120R if the switching stop counter is on (Yes) and moves to step SS125R if not (No). The switching stop counter is a counter that is activated when the (right) amount increasing speed C_{s, R} is switched (changed) in steps S5140R and SS145R.

When the controller 61 moves to step SS120R, the controller 61 determines whether or not the value of the switching stop counter is equal to or larger than a switching standby time, and moves to step SS125R if the value of the switching stop counter is equal to or larger than the switching standby time (Yes) and moves to step SS150R if not (No).

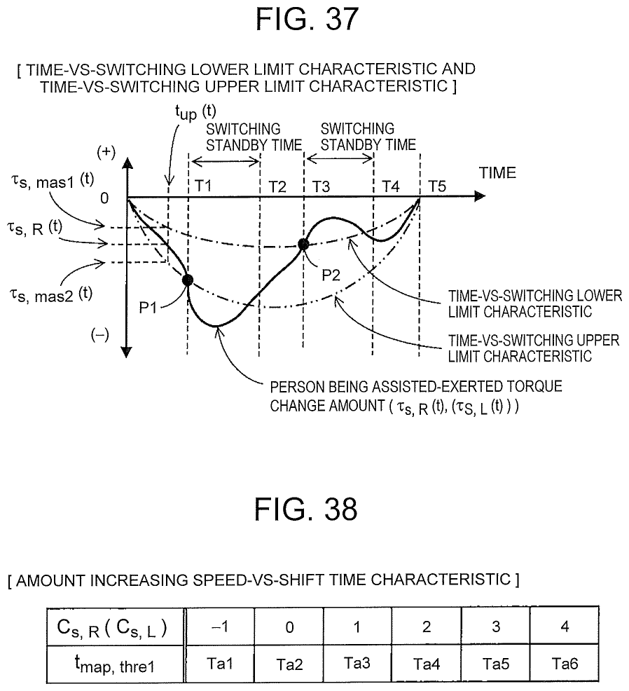

When the controller 61 moves to step SS125R, the controller 61 obtains a switching lower limit τ_{s, mas1} (t) corresponding to the current elapsed lifting time tᵤₚ (t) based on an elapsed lifting time tᵤₚ (t) and a time-vs-switching lower limit characteristic (see FIG. 37). Further, the controller 61 obtains a switching upper limit τ_{s, mas2} (t) corresponding to the current elapsed lifting time tᵤₚ (t) based on the current (right) amount increasing speed C_{s, R}, the elapsed lifting time tᵤₚ (t), and the time-vs-switching upper limit characteristic (see FIG. 37). The elapsed lifting time tᵤₚ (t) is a time that has elapsed since lifting started (the motion state S shifted from 0 to 1). Then, the controller 61 moves to step SS130R. The example shown in FIG. 37 is an example in which the condition “|(right) person being assisted-exerted torque change amount τ_{S, R} (t)|>|switching upper limit τ_{s, mas2} (t)|” is met at time T1 (at the point P1) and the condition “|(right) person being assisted-exerted torque change amount τ_{S, R} (t)|<|switching upper limit τ_{s, mas2} (t)|” is met at time T3 (at the point P2).

In step SS130R, the controller 61 determines whether or not |(right) person being assisted-exerted torque change amount τ_{S, R} (t)| is smaller than |switching lower limit τ_{s, mas1} (t)|, and moves to step SS145R if |(right) person being assisted-exerted torque change amount τ_{S, R} (t)| is smaller than |switching lower limit τ_{s, mas1} (t)| (Yes) and moves to step SS135R if not (No).

When the controller 61 moves to step SS135R, the controller 61 determines whether or not |(right) person being assisted-exerted torque change amount τ_{S, R} (t)| is larger than |switching upper limit τ_{s, mas2} (t)|, and moves to step SS140R if |(right) person being assisted-exerted torque change amount τ_{S, R} (t)| is larger than |switching upper limit τ_{s, mas2} (t)| (Yes) and moves to step SS150R if not (No).

When the controller 61 moves to step SS140R, the controller 61 increases the value of the (right) amount increasing speed C_{s, R} by 1 (with a guard “maximum value=4”) and activates the switching stop counter, and moves to step SS150R.

When the controller 61 moves to step SS145R, the controller 61 decreases the value of the (right) amount increasing speed C_{s, R} by 1 (with a guard “minimum value=−1”) and activates the switching stop counter, and moves to step SS150R.

When the controller 61 moves to step SS150R, the controller 61 obtains (right) t_{map, thre1} based on the (right) amount increasing speed C_{s, R} and the amount increasing speed-vs-shift time characteristic (see FIG. 38), and moves to step S155R. The (right) t_{map, thre1} is used for determination of the motion state (determination of a shift of the motion state from 1 to 2) etc.

In step S155R, the controller 61 determines whether or not this time's (current) (right) amount increasing speed C_{s, R} is equal to the last time's C_{s, R} (see step SS110R), and ends the process and returns (returns to step SU033L in FIG. 33) if this time's (right) amount increasing speed C_{s, R} is equal to the last time's C_{s, R} (Yes) and moves to step SS160R if not (No).

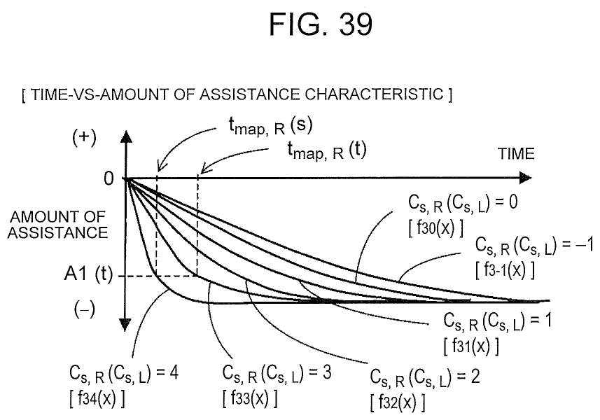

When the controller 61 moves to step SS160R, the controller 61 calculates a temporary lifting assisting torque A1 (t) based on the last time's C_{s, R}, the (right) virtual elapsed time t_{map, R} (t), the time-vs-amount of assistance characteristic (see FIG. 39), the gain Cₚ, and the time-vs-lifting torque characteristic (see FIG. 41). For example, in the case where the last time's C_{s, R}=3, as shown in FIG. 39, the controller 61 calculates the temporary lifting assisting torque A1 (t) from f33 (x) corresponding to C_{s, R}=3 and the (right) virtual elapsed time t_{map, R} (t). As shown in FIG. 39, the time-vs-amount of assistance characteristic (one of the reference lifting characteristics) is prepared according to the (right) amount increasing speed C_{s, R} and the (left) amount increasing speed C_{s, L}, and the controller 61 changes the reference lifting characteristic according to the (right) amount increasing speed C_{s, R} and the (left) amount increasing speed C_{s, L}.

The controller 61 calculates a torque difference-reducing virtual elapsed time t_{map, R} (s) corresponding to the temporary lifting assisting torque A1 (t) based on this time's (current) (right) amount increasing speed C_{s, R}, the time-vs-amount of assistance characteristic (see FIG. 39), the gain Cₚ, and the time-vs-lifting torque characteristic (see FIG. 41), and assigns the calculated torque difference-reducing virtual elapsed time t_{map, R} (s) to the (right) virtual elapsed time t_{map, R} (t) (rewrites the (right) virtual elapsed time t_{map, R} (t) with the calculated torque difference-reducing virtual elapsed time t_{map, R} (s)). To use the time-vs-lifting torque characteristic, for example, in the case where the gain Cₚ=2.6, a value in the characteristic of the gain Cₚ=2 and a value in the characteristic of the gain Cₚ=3 may be obtained, and a value corresponding to Cₚ=2.6 may be obtained from these two values by interpolation. For example, in the case where this time's (current) (right) amount increasing speed C_{s, R}=4, as shown in FIG. 39, the controller 61 calculates the torque difference-reducing virtual elapsed time t_{map, R} (s) from f34 (x) corresponding to C_{s, R}=4 and the temporary lifting assisting torque A1 (t), and assigns the torque difference-reducing virtual elapsed time t_{map, R} (s) to the (right) virtual elapsed time t_{map, R} (t). Then, the controller 61 ends the process and returns (returns to step SU033L in FIG. 33). The rewriting of the (right) virtual elapsed time t_{map, R} (t) corresponds to on-switching torque difference-reducing correction of, when the motion state S has shifted to a predetermined motion state S (in this case, when the motion state S has shifted to 1), reducing the difference between the lifting assisting torque (temporary lifting assisting torque A1(t)) obtained based on the selected reference lifting characteristic (the time-vs-amount of assistance characteristic corresponding to the last time's (right) amount increasing speed C_{s, R} (see FIG. 39)) and the lifting assisting torque obtained based on the currently selected reference lifting characteristic (the time-vs-amount of assistance characteristic corresponding to this time's (current) (right) amount increasing speed C_{s, R} (see FIG. 39)).

In the above description, the time-vs-amount of assistance characteristic (see FIG. 39), and the time-vs-lifting torque characteristic and the forward leaning angle-vs-maximum lifting torque characteristic (see FIG. 41) correspond to reference lifting characteristics having a set lifting assisting torque that is a torque in the lifting direction. The controller 61 selects an appropriate reference lifting characteristic and obtains the lifting assisting torque based on the selected reference lifting characteristic, and drives the actuator unit based on the assisting torque that is the obtained lifting assisting torque. To use the time-vs-lifting torque characteristic, for example, in the case where the gain Cₚ=2.6, a value in the characteristic of the gain Cₚ=2 and a value in the characteristic of the gain Cₚ=3 may be obtained, and a value corresponding to Cₚ=2.6 may be obtained from these two values by interpolation.

Next, the process SS170R in step SU037R shown in FIG. 33 will be described in detail by using FIG. 40. In the process SS170R, the controller 61 obtains the (right) lifting assisting torque ((right) assisting torque command value τ_{s, cmd, R} (t)). For the process SS170R, the procedure of the process of obtaining the (right) lifting assisting torque ((right) assisting torque command value τ_{s, cmd, R} (t)) is shown. The procedure of the process SS170 (see FIG. 33) of obtaining the (left) lifting assisting torque ((left) assisting torque command value τ_{s, cmd, L} (t)) is similar and therefore the description thereof will be omitted.

In the process SS170R, the controller 61 moves to step SS175R. In step SS175R, the controller 61 calculates (temporary) τ_{s, cmd, R} (t) based on this time's (current) (right) amount increasing speed C_{s, R}, the (right) virtual elapsed time t_{map, R} (t), the gain Cₚ, the time-vs-amount of assistance characteristic (see FIG. 39), and the time-vs-lifting torque characteristic (see FIG. 41), and moves to step SS177R. For example, in the case where this time's (current) (right) amount increasing speed C_{s, R}=3, as shown in FIG. 39, the controller 61 stores, as (temporary) τ_{s, cmd, R} (t), the assisting torque A1 (t) obtained from f33 (x) corresponding to C_{s, R}=3 and the (right) virtual elapsed time t_{map, R} (t). To use the time-vs-lifting torque characteristic, for example, in the case where the gain Cₚ=2.6, a value in the characteristic of the gain Cₚ=2 and a value in the characteristic of the gain Cₚ=3 may be obtained, and a value corresponding to Cₚ=2.6 may be obtained from these two values by interpolation.

In step SS177R, the controller 61 calculates a (right) torque upper limit value τ_{s, max, R} (t) based on the forward leaning angle and the forward leaning angle-vs-maximum lifting torque characteristic (see FIG. 41), and moves to step SS180R. For example, the controller 61 stores, as the (right) torque upper limit value τ_{s, max, R} (t), a maximum lifting torque B1 (t) obtained from the forward leaning angle-vs-maximum lifting torque characteristic shown in FIG. 41 and the (right) link angle (forward leaning angle) θ_{L, R} (t). The torque value of the lifting torque is limited by the “forward leaning angle-vs-maximum lifting torque characteristic” so as not to become too large when the forward leaning angle is small.

In step SS180R, the controller 61 determines whether or not |(temporary) τ_{s, cmd, R} (t)| is larger than |(right) torque upper limit value τ_{s, max, R} (t)|, and moves to step SS185R if |(temporary) τ_{s, cmd, R} (t)| is larger than |(right) torque upper limit value τ_{s, max, R} (t)| (Yes) and moves to step SS187R if not (No).

When the controller 61 moves to step SS185R, the controller 61 stores the (right) torque upper limit value τ_{s, max, R} (t) as the (right) lifting assisting torque ((right) assisting torque command value τ_{s, cmd, R} (t)), and ends the process and returns (returns to step SU037L in FIG. 33).

When the controller 61 moves to step SS187R, the controller 61 stores (temporary) τ_{s, cmd, R} (t) as the (right) lifting assisting torque ((right) assisting torque command value τ_{s, cmd, R} (t)), and ends the process and returns (returns to step SU037L in FIG. 33).

Thus, the assist device 1 described in the embodiment has a simple configuration and can be easily worn by a person being assisted. The assisting control for a lowering task and the assisting control for a lifting task are both simple, and the assist device 1 can appropriately provide assistance in a baggage lifting task and a baggage lowering task. Moreover, when assisting a baggage lifting or lowering motion, the assist device 1 can automatically adjust the amount of assisting torque according to the mass or weight of baggage that the person being assisted is holding, thereby reducing an unpleasant sensation or dissatisfaction that the person being assisted may feel (improving the adaptability of assistance). In addition, generating an unnecessary assisting torque can be avoided when the person being assisted is not holding baggage (the assist device 1 can be set so as to generate hardly any assisting torque when the gain Cₚ=0), so that the motion of the person being assisted who is not holding baggage is not hindered.

Various changes, additions, and omissions can be made to the structure, configuration, shape, external appearance, processing procedure, etc. of the assist device of the present disclosure to such an extent as not to change the gist of the disclosure. For example, the processing procedure of the controller is not limited to the flowchart etc. described in the above embodiment. While the example of using the spiral spring 45R (see FIG. 10) has been described in the embodiment, a torsion spring (a torsion bar or a torsion bar spring) may be used instead of a spiral spring.

In the embodiment of the assist device 1 described above, the example of using an adjuster or a buckle as the belt retaining member for retaining a belt in a fastened state has been described. The example of connecting and disconnecting the belt etc. by a buckle has been described, but a belt retaining member other than a buckle may also be used to connect and disconnect the belt etc. While in the above example the belt is passed through the adjuster such that the tensioned belt does not loosen, a belt retaining member other than an adjuster may also be used. Alternatively, a belt retaining member having the functions of both an adjuster and a buckle may also be used.

In the above embodiment, the example of the manipulation unit R1 having both the gain upward and downward manipulation parts R1BU, R1BD and the amount increasing speed upward and downward manipulation parts R1CU, R1CD has been described. However, the manipulation unit R1 may be configured to have at least either the gain upward and downward manipulation parts R1BU, R1BD or the amount increasing speed upward and downward manipulation parts R1CU, R1CD.

In the embodiment of the assist device 1 described above, the example in which the motion mode, the gain, the amount increasing speed, etc. can be changed through the manipulation unit R1 has been described. Alternatively, the controller 61 may be provided with the communication means 64 (that communicates in a wireless or wired manner; see FIG. 15) such that such changes can be made through communication from a smartphone etc. The controller 61 may include the communication means 64 (that communicates in a wireless or wired manner; see FIG. 15), and the controller 61 may collect various pieces of data and send the collected pieces of data to an analysis system at predetermined timing (e.g., at all times, at regular time intervals, or at the end of an assisting motion). Examples of the data to be collected include person-being-assisted information and assistance information. For example, the person-being-assisted information is information on the person being assisted, including the person being assisted-exerted torque and the posture of the person being assisted. For example, the assistance information is information on inputs into and outputs from the right and left actuator units, including the assisting torque, the rotation angle of the electric motor (actuator) (the actual motor shaft angle θ_{rM} in FIG. 15), the output link turning angle (the actual link angle θ_{L} in FIG. 15), the motion mode, the gain, and the amount increasing speed. The analysis system is a system that is prepared separately from the assist device, and that is incorporated in a device, for example, an external personal computer, a server, a programmable logic controller (PLC), or a computerized numerical control (CNC) device, connected via a network (LAN). The analysis system may analyze (calculate) optimal setting values (optimal values of the gain, the amount increasing speed, etc.) specific to the assist device 1 (i.e., specific to the person being assisted), and analysis information including the optimal setting values that are an analysis result (calculation result) may be sent to the controller 61 (communication means 64) of the assist device 1. By analyzing the motion of the person being assisted, an assisting force, etc. by the analysis system, it is possible to output an optimal assisting torque with the type of task (repetitive or not, the height of lifting, etc.) and the capacity of the person being assisted taken into account. Based on the analysis information (e.g., the gain and the amount increasing speed) received from the analysis system, the right and left actuator units adjust their own operations (e.g., change the gain and the amount increasing speed to those that have been received).

In the description of the embodiment, the example in which the gain Cₚ is obtained using the person-being-assisted mass M and the baggage mass m has been described. Alternatively, the gravitational acceleration rate g may be used to obtain the gain Cₚ by the person-being-assisted weight (M*g) and the baggage weight (m*g).

In the description of the embodiment, the example in which the load detection means is provided on the soles of the right and left feet of the person being assisted has been described. Alternatively, the person being assisted may wear gloves on his or her right and left hands, and the load detection means may be provided in these right and left gloves. In this case, the baggage mass (or baggage weight) can be detected from a load detected by the load detection means, and the detected baggage mass (or baggage weight) can be converted into the gain Cₚ. Instead of the load detection means provided on the soles of the right and left feet or in the right and left gloves, a plurality of switches that detect presence or absence of a load may be provided. For example, when these switches are switches that turn on under a weight of 2 [kg] or more, an approximate weight of the baggage can be detected from the number of the switches that have turned on.

What is claimed is:

1. An assist device comprising:
body gear worn at least around hips of a person being assisted;
an actuator unit attached to the body gear and worn on thighs of the person, the actuator unit being configured to generate an assisting torque for assisting a predetermined motion of the person, the predetermined motion being at least either a motion of the thighs of the person relative to his or her hips or a motion of the hips of the person relative to his or her thighs;
an angle detector configured to detect a forward leaning angle of the hips of the person relative to his or her thighs;
a torque detector configured to detect a torque-related amount that is related with a torque based on the forward leaning angle detected by the angle detector;
a load detector configured to detect a load-related amount based on either a baggage mass or a baggage weight, the baggage mass being a mass of baggage that the person is holding, the baggage weight being a weight of the baggage; and
a controller configured to calculate the assisting torque based on the torque-related amount and the load-related amount, the controller being configured to control the actuator unit based on the calculated assisting torque.

2. The assist device according to claim 1, wherein:
the load detector is disposed on soles of feet of the person;
the controller is configured to detect a person-being-assisted mass that is the mass of the person, based on a detection signal sent from the load detector when the person is not holding the baggage;
the controller is configured to detect a combined mass that is a total mass of the person and the baggage, based on a detection signal sent from the load detector when the person is holding the baggage; and
the controller is configured to detect the baggage mass based on the combined mass and the person-being-assisted mass.

3. The assist device according to claim 1, wherein:
the load detector is disposed on the soles of feet of the person;
the controller is configured to detect a person-being-assisted weight that is the weight of the person, based on a detection signal sent from the load detector when the person is not holding the baggage;
the controller is configured to detect a combined weight that is a total weight of the person and the baggage, based on a detection signal sent from the load detector when the person is holding the baggage; and
the controller is configured to detect the baggage weight based on the combined weight and the person-being-assisted weight.

4. The assist device according to claim 1, further comprising an acceleration rate detector configured to detect a body motion acceleration rate that is an acceleration rate of a motion of a part of the body of the person, wherein the controller is configured to calculate the load-related amount based on one of the baggage mass and the baggage weight detected by the load detector and on the body motion acceleration rate detected by the acceleration rate detector.

5. The assist device according to claim 1, further comprising a storage device that stores a plurality of maps in which an assisting torque-related amount related with the assisting torque is preset according to the load-related amount, wherein the controller is configured to calculate the assisting torque by using one of the maps selected based on the load-related amount when obtaining the assisting torque.

6. The assist device according to claim 1, wherein:
the controller includes a storage part for learning; and
the controller is configured to cause the storage part to store a learning model created by machine learning and configured to adjust a gain in the assisting torque by using a learning model.
